(19) United States
(12) Patent Application Publication
(10) Pub. No.: US 2026/0323364 A1
(43) Pub. Date: Oct. 15, 2026

(54) Methods and Apparatus for Enabling Low Latency Throughput in Wireless Local Area Networks (WLANs) Through Use of Stream Classification Service

(71) Applicant: Charter Communications Operating, LLC, St. Louis, MO (US)

(72) Inventors: Maulik Vaidya, Escondido, CA (US); Nima Namvar, Charlotte, NC (US)

(21) Appl. No.: 19/177,342

(22) Filed: Apr. 11, 2025

(51) Int. Cl. H04W 28/02; H04W 84/12

(52) U.S. Cl. CPC H04W 28/0236; H04W 84/12

(57) ABSTRACT

A first communications device and a second communications device support low latency treatment for data flows. The first communications device monitors for and detects congestion based on a received ECN value, communicated in a received MSDU, and the status of an internal buffer. The first communications device transmits a Stream Classification Service (SCS) request frame including a latency descriptor element including information relating to treatment of a first data flow to a second communications device. The first communications device creates a SCS filter and activates LL treatment for the flow. The first communications device applies a low latency treatment, e.g., a MAC layer LL treatment, to a first medium access control (MAC) service data unit (MSDU) corresponding to said first data flow and transmits the first MSDU to second communications device with LL priority.

### FIELD

The present invention is directed to wireless communications, and more particularly, to methods and apparatus for supporting low latency throughput in WLANs.

### BACKGROUND

L4S stands for Low Latency, Low Loss, Scalable Throughput. It is a relatively new technology which was introduced by IETF (see, e.g., Internet Engineering Task Force (IETF) RFC 9330, Low Latency, Low Loss, and Scalable Throughput (L4S) Internet Service: Architecture, January 2023 and Internet Engineering Task Force (IETF) RFC 9331, The Explicit Congestion Notification (ECN) Protocol for Low Latency, Low Los, and Scalable Throughput (L4S), January 2023) to address the queueing delay for Internet Protocol (IP) traffic.

L4S uses a dual queue implementation, in which network traffic is separated into two queues, one queue for L4S traffic and another queue for traditional Transmission Control Protocol (TCP) traffic. L4S uses Explicit Congestion Notification (ECN) signaling.

FIG. 1 is a drawing of an exemplary Internet Protocol (IP) header 100 including an Explicit Congestion Notification (ECN) portion 140 (used for L4S) and a legend 150 illustrating the mapping of ECN bit values. IP header 100 includes 16 bits (Bit 0 102, Bit 1 104, Bit 2 106, Bit 3, 108, Bit 4 110, Bit 5 112, Bit 6 114, Bit 7 116, Bit 8 118, Bit 9 120 Bit 10 122, Bit 11 124, Bit 12 126, Bit 13 128, Bit 14 130, Bit 15 132). First IP header portion 134, which includes Bit 0 102, Bit 1 104, Bit 2 106 and Bit 3 108, is used to convey the IP version, e.g. IP version=4. Second IP header portion 136, which includes Bit 4 110, Bit 5 112, Bit 6 114 and Bit 7 116, is used to convey the Header Length (Len). Third IP header portion 138, which includes Bit 8 118, Bit 9 120, Bit 10 122, Bit 11 124, Bit 12 126, and Bit 13 128, is used to convey Differential Service Code Point (DSCP). Fourth IP header portion 140 which includes Bit 14 130, which is the ECT bit, and Bit 15 132, which is the CE bit, is used to convey the Explicit Congestion control Notification (ECN) bits.

Legend 150 indicates: ECN bit pattern=00 means not ECN capable; ECN bit pattern=10 means classic ECN-capable transport; ECN bit pattern=01 means L4S-capable transport; and ECN bit pattern=11, which is the congestion experienced codepoint, means congestion experienced.

With ECN signaling, in addition to the 6-bit DSCP header, the ECN bits in the IP header are used by the sender to mark its packet as “L4S capable”. Network sends an early congestion signal by marking IP packet with a Congestion-experienced code (CE). Sender adjusts its transmission rate dynamically based on the received congestion signals.

Means to convey not just L4S support, but also latency requirements of a given flow are generally not well specified in IEEE 802.11-REVme/D5.0, Part 11: Wireless LAN Medium Access Control (MAC) and Physical Layer (PHY) Specifications, February 2024 which is hereby expressly incorporated by reference in its entirety.

Two broad frameworks within IEEE 802.11-REVme/D5.0 provide consumption of various properties and expectations of application-generated flows by upper-layers (to U-MAC): framework (a): (Application layer <->) User Priorities <-> Access Categories mapping, and framework (b): Stream Classification Service (SCS) introduced in 802.11aa.

Previous contributions (e.g., document IEEE 802.11-23/0650r1, titled QoS Revisited, dated 2023-05-17) have already presented thoughts in or around applicability of framework (a). Aspects of framework (a) are implementation dependent, i.e. there may be a large variance in 802.11be AP implementation by vendor X vs vendor Y, with regard to: (i) understanding the characteristics of the same application flow (say streaming live video) in the same manner and (ii) applying appropriated flow treatment (including scheduling priorities).

Framework (b), which is SCS, largely deals with {AC_VO (Access Category_Voice), AC_VI (Access Category_Video)} types of flows. Modern day application flows are increasingly hard to bucketize (by virtue of its packet delay budget, jitter requirements, etc. c.f. [2]) in such limited (4,6,8) categories of flow treatments. However, the framework (b), SCS framework, does provide a slightly more flexible way (compared to framework (a)) to consume desired per-flow treatment between STAs and APs. Means to relay TCP/IP-related parameters is also provided via SCS Descriptor->TCAS->Frame Classifier->Classifier Type (value=1, 4).

FIG. 2 is a drawing 200 illustrating exemplary frame classifier field format information. The frame classifier field 201 includes a classifier type portion 202, a classifier mask portion 204 and a classifier parameters portion 208. Information 208 indicates: i) the size of the classifier type portion 202 is 1 octet, ii) the size of the classifier mask portion is 1 or 3 octets, and iii) the size of the classifier parameters portion 206 is variable.

FIG. 3 is a frame classifier type table 300, which maps different values for the classifier type parameter to different types of classifier parameters. First column 302 includes classifier type information and second column 304 includes classifier parameters. Row 306 indicates that a classifier type value=0, indicates that the classifier parameters are Ethernet parameters. Row 308 indicates that a classifier type value=1, indicates that the classifier parameters are Transmission Control Protocol/User Datagram Protocol (TCP/UDP) IP parameters. Row 310 indicates that a classifier type value=2, indicates that the classifier parameters are IEEE 802.1Q-2003 parameters (deprecated Y #56). Row 312 indicates that a classifier type value=3, indicates that the classifier parameters are filter offset parameters. Row 314 indicates that a classifier type value=4, indicates that the classifier parameters are IP and higher level parameters. Row 316 indicates that a classifier type value=5, indicates that the classifier parameters are IEEE 802.1Q-2003 parameters (#56). Row 318 indicates that a classifier type value=6, indicates that the classifier parameters are IEEE 802.11 MAC header parameters. Row 320 indicates that a classifier type value=7, indicates that the classifier parameters are IEEE STD 802.11 downlink Protocol Version 1 (PV1) MAC Protocol Data Unit (MPDU) MAC header parameters (from DS field of the frame control field equal to 1). Row 322 indicates that a classifier type value=8, indicates that the classifier parameters are IEEE STD 802.11 downlink PV1 MPDU MAC header parameters (from Distribution Server (DS) field of the frame control field equal to 0). Row 324 indicates that a classifier type value=9, indicates that the classifier parameters are IEEE STD 802.11 PV1 MPDU full address MAC header parameters. Row 326 indicates that a classifier type value=10, indicates that the classifier parameters are IP extensions and higher layer parameters. Row 328 indicates that classifier type values in the range of 11-25 are reserved.

However, typically it is flows corresponding to {AC_BE (Access Category_Best Effort), AC VI (Access Category_Video)} which are prone to queue-building ([2], [4], [6]) in intermediary or final nodes of an end-to-end (e2e) chain.

Also, employment of SCS in an AP or STA is governed by dot 11RobustAVStreamingImplmented (See section 11.25.1 of IEEE 802.11-REVme/D5.0, Part 11: Wireless LAN Medium Access Control (MAC) and Physical Layer (PHY) Specifications, February 2024), which in turn is dictated by voice and/or data related flows; not necessarily, e.g., gaming. Furthermore, ECN bits are not presently conveyed in TCLAS (Traffic Classification). Hence the use of SCS to cover non-video type queue building traffic flows may not be covered adequately.

Based on the above discussion, there is a need for new methods and apparatus to improve throughput for various different types of low latency traffic flows, e.g., gaming traffic flows which have strict latency requirements or goals. It would be advantages if at least some of these new methods and apparatus leveraged SCS and/or ECN structures.

### SUMMARY

Methods and apparatus, in accordance with the present invention, are directed to improving throughput for various different types of low latency traffic flows, e.g., gaming traffic flows. In some embodiments, a low latency flow treatment support field is included as part of a UHR MAC capability information field. An access point (AP), e.g., WiFi AP, and a station (STA) notify each other that they support the new low latency flow treatment feature, in accordance with the present invention.

A first communications device, e.g., an access point, and a second communications device, e.g., a STA, support low latency flow treatment for data flows. The first communications device monitors for and detects congestion based on a received ECN value, communicated in a received MSDU, and the status of an internal buffer. The first communications device transmits a Stream Classification Service (SCS) request frame including a latency descriptor element including information relating to treatment of a first data flow to the second communications device. In some embodiments, the latency descriptor element includes: one or more or all of: an ECN field value, ECN threshold value, a latency target value, desired bandwidth, and a loss tolerance. The first communications device creates a SCS filter and activates LL treatment for a flow. The first communications device applies a low latency treatment, e.g., a MAC layer LL treatment, to a first medium access control (MAC) service data unit (MSDU) corresponding to said first data flow and transmits the first MSDU to second communications device with LL priority.

An exemplary method of operating a first communications device, in accordance with some embodiments, comprises: transmitting from the first communications device to a second communications device a Stream Classification Service (SCS) request frame including a latency descriptor element including information relating to treatment of a first data flow; applying, at the first device, a low latency treatment to a first medium access control (MAC) service data unit (MSDU) corresponding to said first data flow; and transmitting the first MSDU from the first communications device to the second communications device.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary Internet Protocol (IP) header including an Explicit Congestion Notification (ECN) portion (used for L4S) and a legend illustrating the mapping of ECN bit values.

FIG. 2 is a drawing illustrating exemplary frame classifier field format information.

FIG. 3 is a frame classifier type table, which maps different values for the classifier type parameter to different types of classifier parameters.

FIG. 4 is drawing of an exemplary communications system in accordance with an exemplary embodiment.

FIG. 5 is a drawing of an exemplary Quality of Service (QoS) characteristic element in accordance with an exemplary embodiment.

FIG. 6 is a drawing of an exemplary Ultra High Reliability (UHR) capabilities element, in accordance with an exemplary embodiment.

FIG. 7 is a drawing of an exemplary Stream Classification Service (SCS) Request Frame in accordance with an exemplary embodiment.

FIG. 8 is a drawing of an exemplary Stream Classification Service (SCS) Response Frame in accordance with an exemplary embodiment.

FIG. 9 is a signaling drawing illustrating a frame exchange between a station (STA) and an access point (AP), for establishing the IEEE 802.11 association, in which low latency flow treatment is communicated, in accordance with an exemplary embodiment.

FIG. 10 is a flowchart of an exemplary method of operating a communications system in accordance with an exemplary embodiment.

FIG. 11A is a first part of a signaling diagram illustrating components of an exemplary system and a setup and termination protocol exchange, with regard to downlink, in accordance with an exemplary embodiment.

FIG. 11B is a second part of a signaling diagram illustrating components of an exemplary system and a setup and termination protocol exchange, with regard to downlink, in accordance with an exemplary embodiment.

FIG. 11 comprises the combination of FIG. 11A and FIG. 11B.

FIG. 12 is a flowchart of an exemplary method of operating a communications system in accordance with an exemplary embodiment.

FIG. 13A is a first part of a signaling diagram illustrating components of an exemplary system and a setup and termination protocol exchange, with regard to uplink, in accordance with an exemplary embodiment.

FIG. 13B is a second part of a signaling diagram illustrating components of an exemplary system and a setup and termination protocol exchange, with regard to uplink, in accordance with an exemplary embodiment.

FIG. 13 comprises the combination of FIG. 13A and FIG. 13B.

FIG. 14 is a drawing of an exemplary access point (AP) in accordance with an exemplary embodiment, said exemplary AP, e.g., a WiFi AP, supporting a version of SCS which includes support for low latency treatment.

FIG. 15 is a drawing of an exemplary client device station (STA) in accordance with an exemplary embodiment, said exemplary STA supporting a version of SCS which includes support for low latency treatment.

FIG. 16 is a drawing of an exemplary Internet Protocol (IP) header including an Explicit Congestion Notification (ECN) portion (used for low latency) and a legend illustrating the mapping of ECN bit values.

### DETAILED DESCRIPTION

Various embodiments, in accordance with the present invention, allow characterization of latency-sensitive flows by non-AP STA, e.g., end user device client STAs, and AP STAs. In various embodiments, the QoS mechanism introduced in IEEE 802.11 be is extended to facilitate characterization of various types of latency-sensitive flows. IEEE Std 802.11 uses a shared medium and provides differentiated control of access to the medium to handle data transfers with QoS requirements. The QoS facility (per MSDU traffic category and TSPEC negotiation) allows an IEEE 802.11 LAN to become part of a larger network providing end-to-end QoS delivery or to function as an independent network providing transport on a per-link basis with specified QoS commitments.

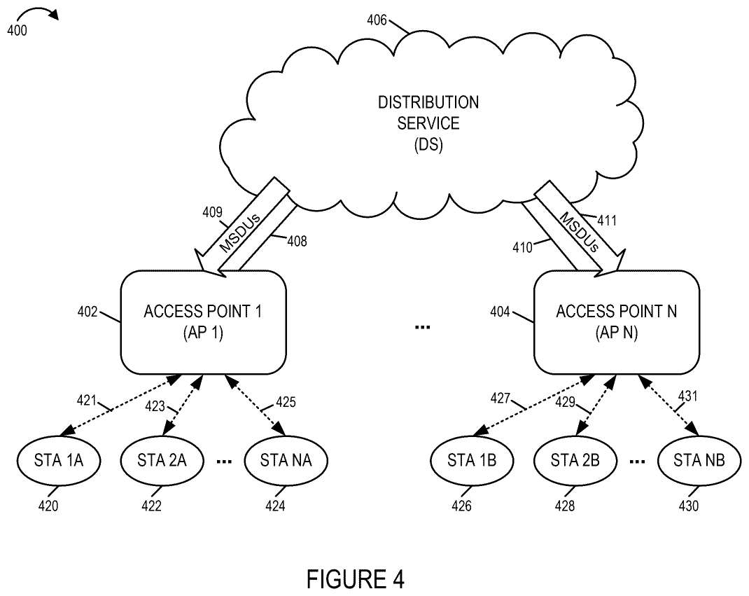

FIG. 4 is drawing of an exemplary communications system 400 in accordance with an exemplary embodiment. Exemplary communications system 400 includes a distribution service (DS) 406, a plurality of access points (APs), and a plurality of stations (STAs) coupled together as shown. The plurality of access points (APs) includes access point 1 (AP 1) 402 and access point N (AP N) 404. The plurality of stations (STAs) includes STA 1A 420, STA 2A 422, STA NA 424, STA 1B 426, STA 2B 428, and STA NB 430. AP 1 402 is coupled to DS 406 via communications link 408. AP N 404 is coupled to DS 406 via communications link 410. MSDUs 409 are communicated, via communications link 408, from DS 406 to AP 1 402. MSDUs 411 are communicated, via communications link 410, from DS 406 to AP N 404.

STA 1A 420 is coupled to AP 1 402 via wireless communications link 421. STA 2A 422 is coupled to AP 1 402 via wireless communications link 423. STA NA 424 is coupled to AP 1 402 via wireless communications link 425. STA 1B 426 is coupled to AP N 404 via wireless communications link 427. STA 2B 428 is coupled to AP N 404 via wireless communications link 429. STA NB 430 is coupled to AP N 404 via wireless communications link 431.

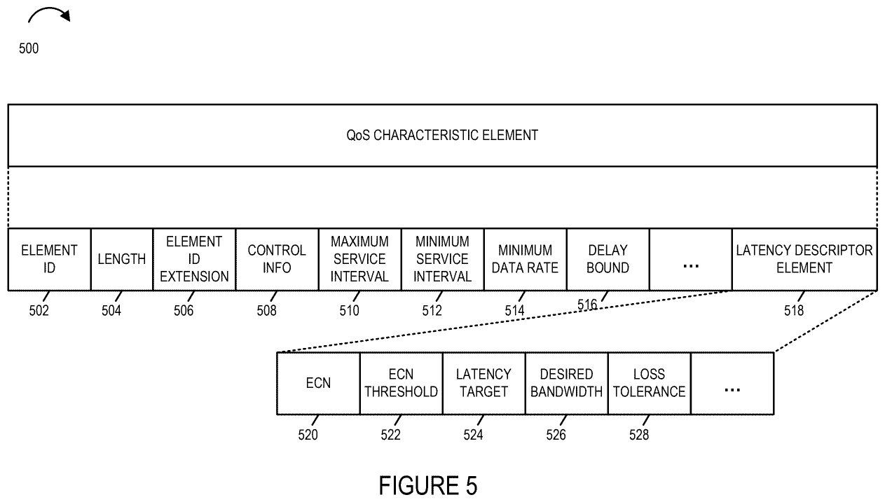

Stream Classification Service (SCS) was enhanced in P802.11be with additional QoS Characteristics for time sensitive traffic flows, which enables a direct mapping of scheduling requirements from 802.1Qbv to 802.11 MAC. Even though the original design focused on time-sensitive flows, the mechanism can be applied to convey additional application-specific latency characteristics of a given flow. A non-AP STA may, and in some embodiments in accordance with present invention does, indicate additional traffic characteristics (via Latency Descriptor Element 518 shown in FIG. 5) expected for a given flow (based on the expectation of triggering or receiving application, e.g., a cloud-gaming application).

FIG. 5 is a drawing of an exemplary Quality of Service (QoS) characteristic element 500 in accordance with an exemplary embodiment. QoS characteristic element 500 includes an element ID field 502, a length field 504, an element ID extension field 506, a control information (info) field 508, a maximum service interval field 810, a minimum data rate field 514, a delay bound field 516 and latency descriptor element field 518. An exemplary latency descriptor element field 518 includes one or more or all of: an ECN 520, a ECN threshold field 522, a latency target field 524, a desired bandwidth field 526 and a loss tolerance field 528.

Latency descriptor element field 518 may, and in some embodiments, does include additional elements, in addition to those shown in FIG. 5. (Non-exhaustive) information which can be, and sometimes is, included in Latency Descriptor Element 518 includes: i) ECN (from IP header): ECN bits (including L4S or L4S-like support, e.g., Low latency support), ii) ECN threshold: defines the congestion level at which the client device starts sending ECN signals, iii) Latency Target: specifies the desired maximum delay for a given traffic flow; iv) Loss Tolerance: defines the acceptable packet loss rate for a given traffic flow; v) Desired Bandwidth: indicates the preferred minimum bandwidth allocation (in e.g., kbps) for a given traffic flow. Note that the ECN is not presently conveyed, and the inclusion of the ECN in the is a novel feature, in accordance with the present invention.

Signaling means to accommodate the addition of the Latency Descriptor Element and associated behavior also needs to be specified. To do so, a new capability element is introduced, implemented, and used, in accordance with the present invention. Note, as is common, each amendment of 802.11 introduces its own amendments-specific capabilities element, e.g., HT (Hight Throughput) Capabilities, VHT (Very High Throughput) Capabilities, EHT (Extremely High Throughput) Capabilities, etc. It is expected that 802.11bn work will also group capabilities under, e.g., UHR (Ultra High Rate) Capabilities. 802.11bn is described in document IEEE Standards Association document P802.11bn having a PAR Approval Date of Sep. 21, 2023. Therefore, in accordance with a feature of the present invention, a proposed new MAC-level capability Low latency flow treatment support will be included under the UHR Capabilities to enable support an employment of embodiments, in accordance with the present invention. If both non-AP and AP STs support this capability, then upon indication of flows warranting specific treatment criteria (as specified by Latency Descriptor Element), AP can perform appropriate resource allocation treatment available to it (e.g., change rTWT, non-secondary channel access, etc.) and inform higher layers of congestion at/below MAC layer.

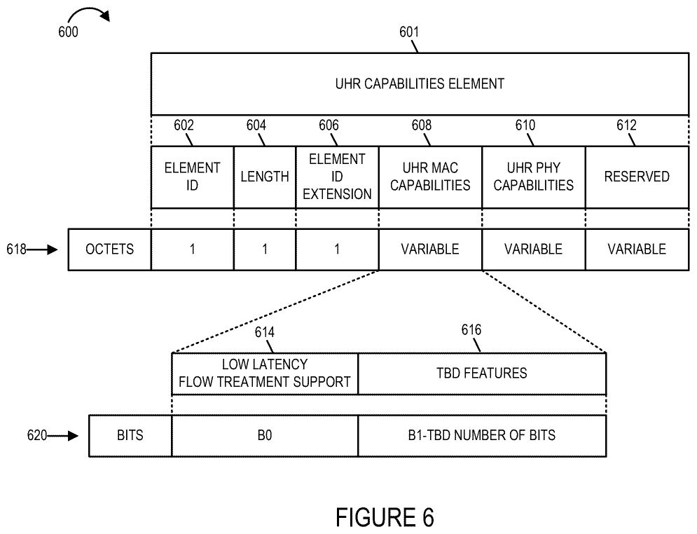

FIG. 6 is a drawing 600 of an exemplary Ultra High Reliability (UHR) capabilities element 601, in accordance with an exemplary embodiment. UHR capabilities element 601 includes an element ID field 602, a length field 604, an element ID extension field 606, a UHR MAC capabilities field 608, a UHR PHY capabilities field 610, and a reserved potion 612. Row 618 indicates the number of octets (1, 1, 1, variable, variable) for each field (element ID 602, length 604, element ID extension 606, UHR MAC capabilities 608, UHR PHY capabilities 610, reserved 612), respectively.

The UHR MAC capabilities field 608 includes a low latency flow treatment support subfield 614 and a TBD (To Be Defined) features field 616. Row 620 indicates the BIT designation for each field. Bit B0 is designated as low latency flow treatment support bit. Bits B1-TBD number of bits corresponds to the TBD features.

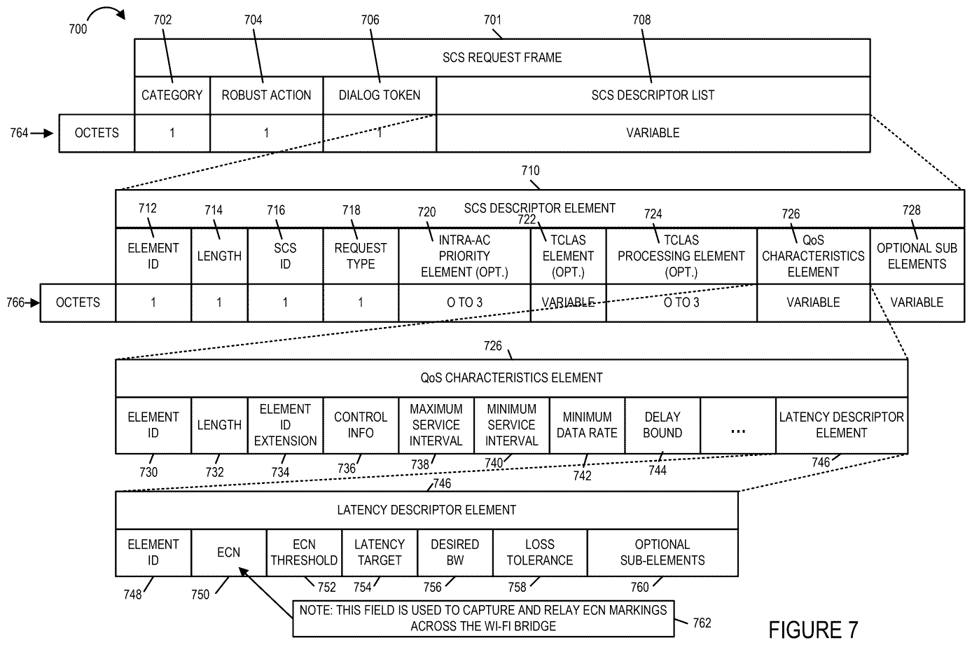

In accordance with a feature of various embodiments, a new “Latency Descriptor Element” is included in the QoS element of the SCS request/response frames. FIG. 7 illustrates the new proposed SCS Request Frame structure. FIG. 7 is a drawing 700 of an exemplary Stream Classification Service (SCS) Request Frame 701 in accordance with an exemplary embodiment. SCS Request Frame 701 includes a category field 702, a robust action field 704, a dialog token field 706, and a SCS descriptor list field 708. Row 764 indicates that the size, in octets, for each of the fields (category 702, a robust action 704, a dialog token 706, and SCS descriptor list 708) is (1, 1, 1, variable), respectively.

SCS Descriptor List 708 includes a SCS Descriptor Element 710. SCS Descriptor Element 710 includes an element ID field 712, a length field 714, a SCS ID field 716, a request type field 718, an optional intra-AC priority element field 720, an optional traffic classification (TCLAS) element field 722, an optional TCLAS processing element field 724, a QoS characteristic element field 726, and optional sub elements field 728. Row 766 indicates that the size, in octets, for each of the fields (element ID 712, length 714, ID 716, request type 718, optional intra-AC priority element 20, optional traffic classification (TCLAS) element 722, optional TCLAS processing element 724, QoS characteristic element 726, and optional sub elements) is (1, 1, 1, 1, 0 to 3, variable, 0 to 3, variable, variable), respectively.

The QoS characteristics element 726 includes an element ID field 730, a length field 732, an element ID extension field 734, a control information field 736, a maximum service interval field 738, a minimum service interval field 740, a minim data rate field 742, a delay bound field 744 and a latency descriptor element field 746.

Latency descriptor element 746 includes an element ID field 748, an ECN field 750, an ECN threshold field 752, a latency target field 754, a desired bandwidth (BW) field 756, a loss tolerance field 758, and an optional sub-elements field 760. Note that the ECN field 750 is used to capture and relay ECN markings across the Wi-Fi bridge, as indicated by information box 762.

Exemplary SCS Request Frame 701 is shown including one SCS Descriptor Element 710 within SCS Descriptor List 708. However, it should be appreciated that SCS Request frame 701 may, and sometimes does, includes a plurality of SCS descriptor elements, e.g., with different SCS descriptor elements corresponding to different SCS IDs.

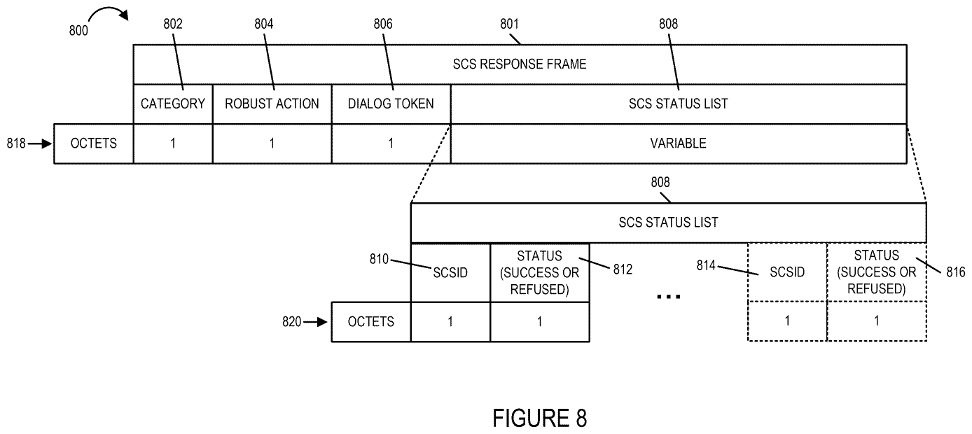

FIG. 8 illustrates the new proposed SCS Response Frame structure. FIG. 8 is a drawing 800 of an exemplary Stream Classification Service (SCS) Response Frame 801 in accordance with an exemplary embodiment. SCS Response Frame 801 includes a category field 802, a robust action field 804, a dialog token field 806, and a SCS status list field 808. Row 818 indicates that the size, in octets, for each of the fields (category 802, robust action 804, dialog token 806, and SCS status list 808) is (1, 1, 1, variable), respectively.

The SCS status list 808 includes one or more SCS status duples as shown in FIG. 8. The SCS status list 808 includes one or more sets of: i) a SCSID field and ii) a corresponding status field, indicating success or refused). For example SCS status list 808 includes at least SCSID field 810 and status field 812. SCS status list 808 may, and sometimes does, include additional fields, e.g., SCSID field 814 and status field 816. Row 820 indicates that the size, in octets, for each of the fields (SCDID field 810, status field 812, . . . , SCSID field 814, . . . status field 816) is (1, 1, . . . , 1, 1), respectively.

The SCSID field is set to the value of the SCSID field in the SCS Descriptor element in the SCS Request frame. The status field indicates the status of the requested SCSID as either “success” or “refused” depending on whether or not the SCS filter with the requested parameters is created or not.

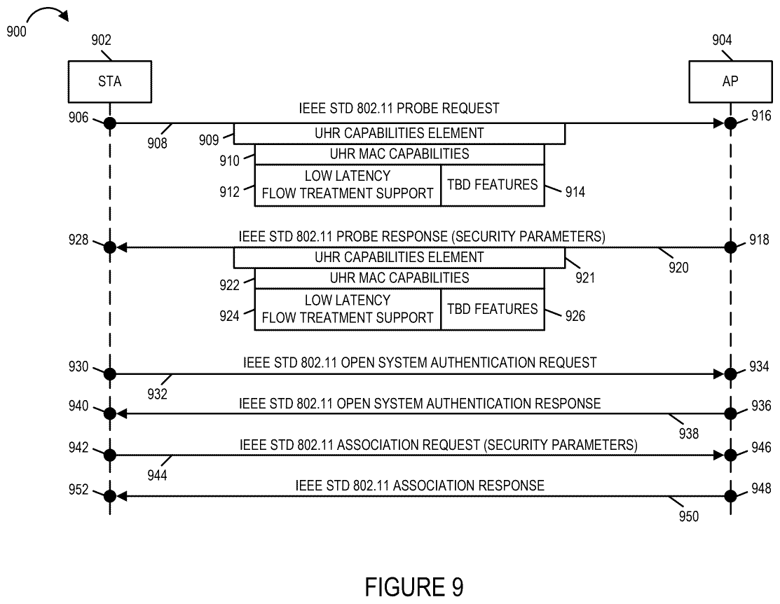

How low latency flow treatment support capability is communicated will now be described. This capability is proposed as a new subfield in the UHR MAC capabilities information field, which is communicated via various management frames, such as Beacon, Association Request, Association Response, Reassociation Request, Reassociation Response, Probe Request, Probe Response, etc. As an example, inf FIG. 9 the frame exchange during the association process is shown, in which the low latency flow treatment capability is communicated.

FIG. 9 is a signaling drawing 900 illustrating a frame exchange between STA 902 and AP 904, for establishing the IEEE 802.11 association, in which low latency flow treatment is communicated, in accordance with an exemplary embodiment.

In step 906 STA 902 generates and sends, e.g., transmits, IEEE STD 802.11 probe request 908 to AP 904. Probe request 908 includes UHR capabilities element 909, which includes UHR MAC capabilities information 910, in a UHR MAC capabilities subfield. The UHR MAC capabilities information 910 includes: an indication 912 of low latency flow treatment support in a low latency flow treatment support subfield and may further include additional TBD features 914. In step 916 the AP 904 receives the probe request 908 and recovers the communicated information including the information indicating that STA 902 supports low latency flow treatment. In step 918, AP 904 generates and sends, e.g., transmits, IEEE STD 802.11 probe response 920, which communicates security parameters. Probe response 920 includes UHR capabilities element 921, which includes UHR MAC capabilities information 922, in a UHR MAC capabilities subfield. The UHR MAC capabilities information 922 includes: an indication 924 of low latency flow treatment support in a low latency flow treatment support subfield and may further include additional TBD features 926. In step 928 the STA 902 receives the probe response 920 and recovers the communicated information including the information indicating that AP 904 supports low latency flow treatment.

In step 930 STA 902 generates and sends, e.g., transmits, IEEE STD 802.11 open system authentication request 932 to AP 904. In step 934 the AP 904 receives the authentication request 932 and recovers the communicated information. In step 936 AP 904 generates and sends, e.g., transmits, IEEE STD 802.11 open system authentication response 938 to STA 902. In step 940 the STA 902 receives the authentication response 938 and recovers the communicated information.

In step 942 STA 902 generates and sends, e.g., transmits, IEEE STD 802.11 association request 944 including security parameters to AP 904. In step 946 AP 904 receives the association request 942 and recovers the communicated information. In step 948 AP 904 generates and sends, e.g., transmits, IEEE STD 802.11 association response 950 to STA 902. In step 952 the STA 902 receives the association response 950 and recovers the communicated information.

Proposed MLME (MAC Sublayer Management Entity) SAP (Service Access Point) primitives, in accordance with features of some embodiments of the present invention will now be described.
MLME-CONGESTION-EXPERIENCED.indication (
source address, --->Set to SA field of the MSDU that experienced congestion
destination address, --->Set to DA field of the MSDU that experienced congestion
priority level, --->The priority level, i.e., access category (AC) of the MSDU that experienced congestion
SCSID, --->Identifies (if any) the SCS stream to which the congestion experienced MSDU belongs
congestion experienced, --->Boolean parameter set to 1 if congestion is experienced and set to 0 otherwise
congestion status, --->Congestion severity (e.g., light, moderate, heavy)
ECN, --- >2-bit ECN codepoint, indicates if the MSDU belongs to a L4S-capable or like L4S capable transport and/or congestion experienced.
congestion threshold, --->Congestion trigger level for applying specific treatment (e.g., LL treatment)
congestion information, --->provides a container for further information related to congestion experienced at the MAC layer. This parameter is included if the congestion experienced parameter is det to 1.
)

This Primitive, MLME-CONGESTION-EXPERIENCED.indication, indicates whether a traffic stream is experiencing congestion at the MAC layer and what the desired QoS parameters are. This primitive is used by MLME to invoke proper action on the MSDUs for the congestion-experienced traffic steam.
MLME-LOW-LATENCY-TREATMENT.confirm (
status, --->Success or refused
source address, --->Set to SA field of the MSDU designated for LL treatment
destination address, --->Set to DA field of the MSDU designated for LL treatment
SCS-config, --- >Classification rules using SCS mechanism set by the .request primitive
SCSID, --->Identifies/updates the SCS stream to which the LL MSDU belongs
QoS parameters, --->Desired QoS characteristics (latency, jitter, loss tolerance, etc.)
bandwidth, --- >bandwidth allocation
)

This primitive, MLME-LOW-LATENCY-TREATMENT.confirm is generated in response to the LL treatment request and indicates whether the mechanism is activated or not.
MLME-LOW-LATENCY-TREATMENT.request (
source address, --->Set to SA field of the MSDU designated for LL treatment
destination address, --->Set to DA field of the MSDU designated for LL treatment
priority level, --->The priority level, i.e., access category (AC) of the MSDU that experienced congestion
SCS-config, --->Classification rules of SCS mechanism
SCSID, --->Identifies/updates the SCS stream to which the LL MSDU belongs QoS parameters, --->Desired QoS characteristics (latency, jitter, loss tolerance, etc.)
Desired bandwidth, --- >Indicates the preferred minimum bandwidth allocation (in e. g, kbps) for a given traffic flow
Congestion status --->ECN value (either read IP header or overwritten by MLME)
)

This primitive, MLME-LOW-LATENCY-TREATMENT.request triggers the Low Latency (LL) treatment for the identified traffic stream MSDU. It is used to set or update the QoS parameters as well as the SCS filter.

An exemplary workflow, in accordance with an exemplary embodiment includes: i) congestion detection, ii) triggering indication, iii) action by higher layers, and iv) low latency treatment at MAC.

Congestion detection will now be described. The MAC layer detects sustained congestion either by reading and consuming the ECN markings or based on real-time metrics.

Triggering indication will now be described. The indication primitive will be generated at MLME and depending on the ECN marking and QoS parameters, proper treatment is triggered.

Action by higher layers will now be described. If the congestion traffic stream is L4S capable or like L4S-capable (depending on the ECN), the sender is proactively notified to reduce the sending rate. Otherwise, other congestion control mechanisms may be, and sometimes are, invoked.

Low latency treatment at MAC will now be described. The MAC layer can, and sometimes does, invoke an LL treatment mechanism, e.g., any LL treatment mechanism, such as, e.g., prioritization, non-primary channel access (a new feature being developed in 802,11 bn TG) and specify the QoS parameters via the SCS mechanism.

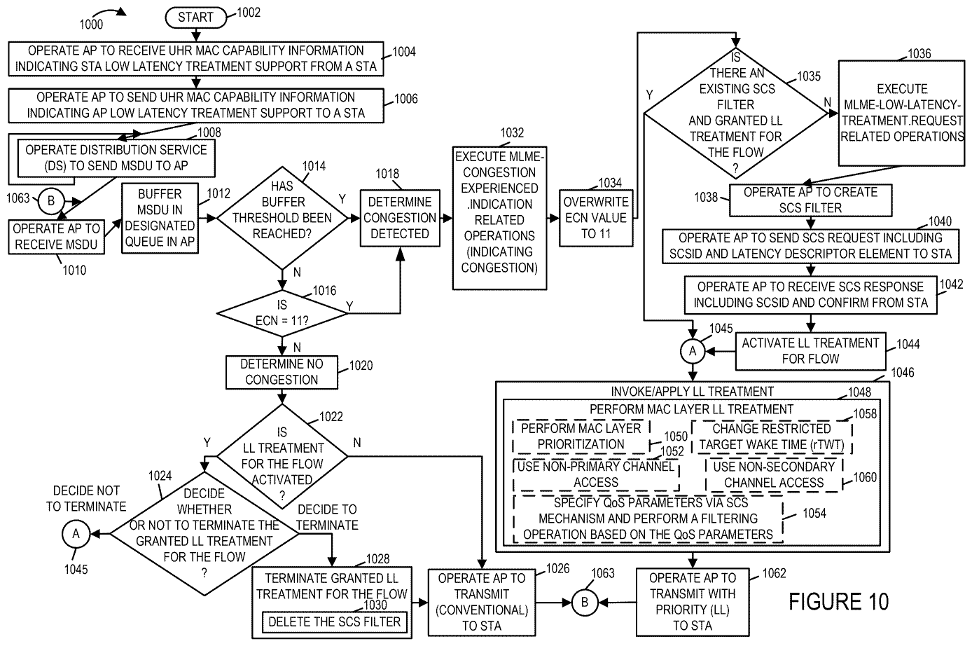

FIG. 10 is a flowchart 1000 of an exemplary method of operating a communications system in accordance with an exemplary embodiment, said method including communication UHR MAC capability information including information indicating support for low latency treatment, receiving MSDUs including ECN bits, monitoring for congestion, creating a SCS filter for a detected congested stream, and applying LL treatment, e.g., at a MAC layer, to facilitate a low latency downlink traffic flow. Operation of the exemplary method starts in step 1002, in which the communications system, e.g., a communications system including an access point AP, a station (STA) and a distribution service (DS), is powered on and initialized. Operation proceeds from start step 1002 to step 1004. In step 1004 the AP is operated to receive UHR MAC capability information indicating STA low latency treatment support from a STA. Operation proceeds from step 1004 to step 1006. In step 1006, the AP is operated to send UHr MAC capability information indicating AP low latency treatment support to the STA. Operation proceeds from step 1006 to step 1008.

In step 1008 a distribution service (DS) is operated to send a MSDU to the AP. Step 1008 may be, and sometimes is, performed multiple times, e.g., corresponding to different MSDUs which are being sent to the AP. Operation proceeds from step 1008 to step 1010. In step 1010 the AP is operated to receive the MDSU. Operation proceeds from step 1010 to step 1012. In step 1012 the AP is operated to buffer the received MSDU in a designated queue in the AP. Operation proceeds from step 1012 to step 1014.

In step 1014 the AP determines if a buffer threshold, corresponding to the buffer in which the MSDU was stored, has been reached. If the determination of step 1014 is that the buffer threshold has been reached, then operation proceeds to step 1018, in which the AP determines that congestion has been detected. However, if the determination of step 1014 is that the buffer threshold has not been reached, then operation proceeds from step 1014 to step 1016.

In step 1016, the AP determines if the ECN field in the header of the received MSDU is set to the bit pattern 11. If the AP determines, in step 1016, that the ECN field in the header of the received MSDU is set to 11, then operation proceeds from step 1016 to step 1018, in which the AP determines that congestion has been detected.

Operation proceeds from step 1018 to step 1032, in which the AP executes MLME-congestion experienced.indication related operations, indicating congestion. Operation proceeds from step 1032 to step 1034, in which the AP overwrites the ECN value to bit pattern 11. Operation proceeds from step 1034 to step 1035.

In step 1035 the AP checks to determine if there is an existing stored SCS filter for the flow and granted LL treatment for the flow. If the AP determines, in step 1035, that there is an existing stored SCS filter for the flow and granted LL treatment for the flow, then operation proceeds from step 1035, via connecting node A 1045, to step 1046, in which the AP invokes/applies LL treatment. However, if the AP determines, in step 1035, that there is not an existing stored SCS filter for the flow and granted LL treatment for the flow, then operation proceeds from step 1035 to step 1036, in which the AP executes MLME-low-latency-treatment.request related operations. Operation proceeds from step 1036 to step 1038, in which the AP creates a SCS filter. Operation proceeds from step 1038 to step 1040, in which the AP sends a SCS request including SCSID and a latency descriptor element to the STA. Operation proceeds from step 1040 to step 1042, in which the AP receives an SCS response including the SCSID and confirmation from the STA. Operation proceeds from step 1042 to step 1044, in which the AP activates LL treatment for the flow. Operation proceeds from step 1044, via connecting node A 1045, to step 1046, in which the AP invokes/applies LL treatment for the flow.

Step 1046 includes step 1048, in which the AP performs MAC layer LL treatment. Step 1048 includes one or more of steps 1050, 1052, 1054, 1058 and 1060. In step 1050 the AP performs MAC layer prioritization. In step 1052 the AP uses non-primary access channel. In step 1054, the AP specifies QoS parameters via an SCS mechanism. In step 1058 the AP changes a restricted target wake time (rTWT). In step 1060 the AP uses non-secondary channel access. Operation proceeds from step 1046 to step 1062, in which the AP, which the AP is operated to transmit the MSDU with priority (LL) to the STA. Operation proceeds from step 1062, via connecting node B 1063 to step 1010, in which the AP receives another MSDU from the DS.

Returning to step 1016, if the AP determines, in step 1016, that the ECN field in the header of the received MSDU is not set to the bit pattern 11, then operation proceeds from step 1016 to step 1020, in which the AP determines that there is no congestion. Operation proceeds from step 1020 to step 1022.

In step 1022, the AP determines if low latency (LL) treatment for the flow is activated. If the determination of step 1022 is that LL treatment for the flow is not activated, then operation proceeds from step 1022 to step 1026, in which the AP is operated to transmit the MSDU (using the conventional approach) to STA. However, if the determination of step 1022 is that LL treatment for the flow is activated, then operation proceeds from step 1022 to step 1024, in which the AP decides whether or not to terminate the granted LL treatment for the flow. If the AP decides, in step 1024, to terminate the granted LL treatment for the flow, then operation proceeds from step 1024 to step 1028, in which the AP terminates the granted LL treatment for the flow. Step 1028 includes step 1030, in which the AP deletes the SCS filter for the flow. Operation proceeds from step 1028 to step 1026, in which the AP is operated to transmit the MSDU (using the conventional approach) to STA. Operation proceeds from step 1026, via connecting node B 1063 to step 1010, in which the AP receives another MSDU from the AP.

Returning to step 1024, if the AP decides, in step 1024, not to terminate the granted LL treatment for the flow, then operation proceeds from step 1024, via connecting node A 1045, to step 1046, in which the AP invokes/applies LL treatment. Step 1046 includes step 1048, in which the AP performs MAC layer LL treatment. Step 1048 includes one or more of: steps 1050, 1052, 1054, 1058 and 1060. In step 1050 the AP performs MAC layer prioritization. In step 1052 the AP uses non-primary access channel. In step 1054, the AP specifies QoS parameters via an SCS mechanism. In step 1058, the AP changes a restricted target wake time (rTWT). In step 1060 the AP uses non-secondary channel access. Operation proceeds from step 1046 to step 1062, in which the AP, which the AP is operated to transmit the MSDU with priority (LL) to the STA. Operation proceeds from step 1062, via connecting node B 1063 to step 1010, in which the AP receives another MSDU from the DS.

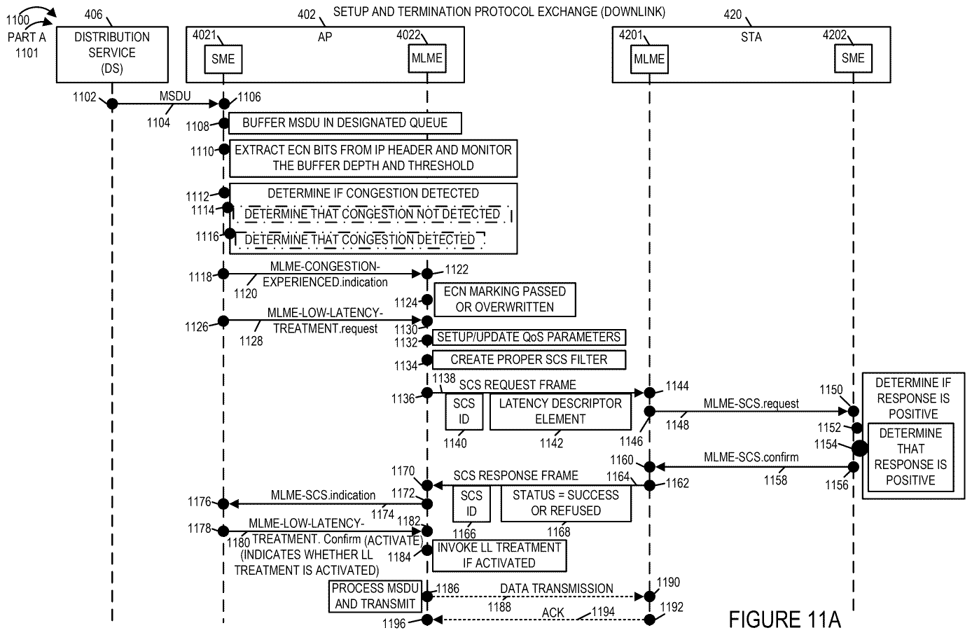

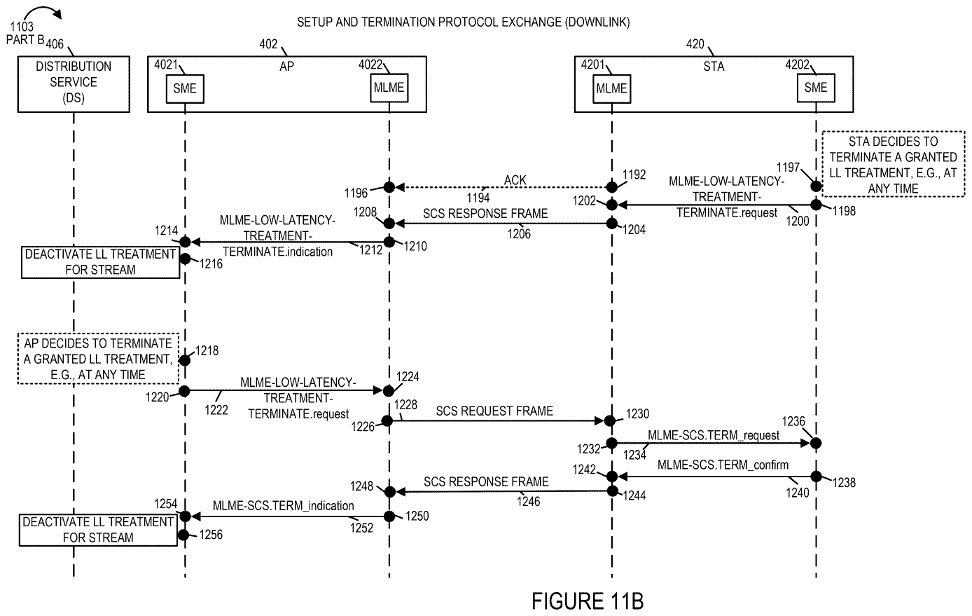

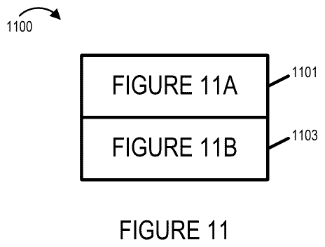

FIG. 11, comprising the combination of FIG. 11A and FIG. 11B, is a signaling diagram 1100, comprising Part A 1101 and Part B 1103, illustrating components of an exemplary system and a setup and termination protocol exchange, with regard to downlink, in accordance with an exemplary embodiment. The exemplary system includes distribution service (DS) 406, access point (AP) 402 and station (STA) 420. AP 402 includes Station Management Entity (SME) 4021 and MAC Layer Management Entity (MLME) 4022. STA 420 includes MAC Layer Management Entity (MLME) 4201 and Station Management Entity (SME) 4202.

In step 1102, DS 406 generates and sends MSDU 1104 to AP 402. In step 1106, AP 402 receives MSDU 1104 and recovers the communicated information including the value of an ECN field. In step 1106 the AP 402 buffers the MSDU in a designated queue. In step 1110 the AP extracts the ECN bits from IP header and monitors the buffer depth and threshold.

In step 1112 the AP determines if congestion has been detected from either the extracted ECN bits indicating congestion, e.g. by a bit pattern set to 11, or by the buffer depth in the AP buffer exceeding the threshold, which indicates congestion in the buffer of the AP. An iteration of step 1112 includes one of step 1114 and step 1116. In step 1114, the AP determines that congestion was not detected. In step 1116, the AP determines that congestion was detected.

In response to a determination that congestion was detected, operation proceeds from step 1116 to step 1118. In step 1118, the SME 4021 of AP 402 generates and sends MLME-Congestion-Experienced.indication message 1120 to MLME 4022 of AP 402, which receives message 1120. In response to message 1120, in step 1124 the AP passes or overwrites the ECN marking, e.g., the ECN marking to be communicated to the STA are set to bit pattern 11 to indicate congestion detected.

In step 1126, the SME 4021 of AP 402 generates and sends MLME-LOW-LATENCY-TREATMEN.request message 1128 to MLME 4022 of AP 402, which receives message 1128. In step 1132 the AP sets up/updates QoS parameters. In step 1134 the AP 402 creates a proper SCS filter.

In step 1136 AP 402 generates and sends SCS request frame 1138, which includes SCSID 1140 and latency descriptor element 1142, to STA 420. The SCS request frame 1138 is received by STA 420 in step 1144, and the communicated information is recovered.

In step 1146 MLME 4201 of STA 420 generates and sends MLME-SCS.reqeust message 1148 to SME 4202 of STA 420, which receives message 1148 in step 1150. In step 1152, STA 420 determines if the response to the received request is positive or negative. In step 1154 the STA determines that the response to the request is positive. In response to the positive determination, in step 1156 the SME 4202 of STA 420 generates and sends a MLME-SCS.confirm message 1158 to MLME 4201 of STA 420, which receives message 1158 in step 1160. In step 1162 STA 420 generates and sends a SCS response frame 1164 including a SCSID 1166 and a status field 1168 indicating success or refused. In this example, since the determination of step 1152 is positive, the positive indication is communicated in message 1158, and status field 1168 is set to indicate success. In step 1170 AP 402 receives SCS response frame 1164 and recovers the communicated information.

In step 1172 MLME 4022 of AP 402 generates and sends MLME-SCS.indication message 1174 to SME 4021 of AP 402, which receives message 1174 in step 1176. In step 1178 the SME 4021 of AP 402 generates and sends MLME-LOW-LATENCY-TREATEMENT.Confirm message 1180 to MLME 4022, which indicates whether or not LL treatment is activated. In this example, the MLME-LOW-LATENCY-TREATME.Confirm message 1180 indicates activated. In step 1182, the MLME 4022 of AP 402 receives message 1180 and recovers the communicated information, e.g. indicating the LL treatment is activated. In step 1184 the AP 402 is operated to invokes LL treatment, if activated for a MSDU to be processed and transmitted. Invoked/applied LL treatments include MAC layer treatments such as, e.g., performing MAC layer prioritization, using non-primary channel access, spefifying QoS parameters via SCS mechanisms, changing restricted target wake time (rTWT) and/or using non-secondary channel access.

In step 1186, the AP 402 processes the MSDU and transmits the MSDU, e.g., with LL priority, to STA 420. Data transmission 1188 represents transmission of the processed MSDU from the AP 402 to the STA 420. In step 1190 STA 420 receives the MSDU communicated in data transmission 1188 and recovers the communicated information. In step 1192, the STA 420 generates and sends ACK message 1194 to AP 402, which receives the ACK in step 1196.

At some point in time the AP 402 or STA 420 may, and sometimes does, decide to terminate a granted LL treatment. For example, in step 1197, STA 420 decides to terminate a granted request, and in step 1198, SME 4202 of STA 420 generates and sends MLME-LOW-LATENCY-TREATMENT-TERMINATE.request 1200 to MLME 4201 of STA 420, which receives message 1200 in step 1202. In response to received message 1200, in step 1204, STA 420 generates and sends a SCS response frame 1206 to AP 402, which communicates the low-latency-treatment-terminate request to AP 402. In step 1208, AP 402 receives the SCS response frame 1206, and recovers the communicated information. In response to the received SCS response frame 1206, the MLME 4022 of AP 402, in step 1210, generates and sends MLME-LOW-LATENCY-TERMINATE.indication message 1212 to SME 4021 of AP 402, which receives message 1212 in step 1214. In response to received message 1212, in step 1214, AP 1216 deactivates the LL treatment for the stream.

As another example, in step 1218, AP 402 decides to terminate a granted LL treatment, and in step 1220, SME 4021 of AP 402 generates and sends MLME-LOW-LATENCY-TREATMENT-TERMINATE.request 1222 to MLME 4022 of AP 402, which receives message 1222 in step 1224. In response to received message 1222, in step 1226, AP 402 generates and sends a SCS request frame 1228 to STA 420, which communicates the low-latency-treatment-terminate request to STA 420. In step 1230, STA 420 receives the SCS request frame 1228, and recovers the communicated information. In response to the received SCS request frame 1228, the MLME 4201 of STA 420, in step 1232, generates and sends MLME-SCS.TERM_request message 1234 to SME 4202 of STA 420, which receives message 1234 in step 1236. In step 1238, SME 4202 of STA 420, in response to the received MLME-SCS.TERM_request message 1234, generates and sends MLME-SCS.TERM_confirm message 1240 to MLME 4201 of STA 420. In step 1242 MLME 4201 of STA 420 receives MLME-SCS.TERM_confirm message 1240, indicating that the response is positive. In step 1244 STA 420 generates and sends a SCS response frame 1246, indicating that status=success, with regard to the request for LL treatment termination. In step 1248, AP 402 receives the SCS response frame 1246 and recovers the communicated information. In response to the received SCS response frame 1246, the MLME 4022 of AP 402, in step 1250, generates and sends MLME-SCS-TERMINATE.indication message 1252 to SME 4021 of AP 402, which receives message 1252 in step 1254. In response to received message 1252, in step 1254, AP 402, in step 1256, deactivates the LL treatment for the stream.

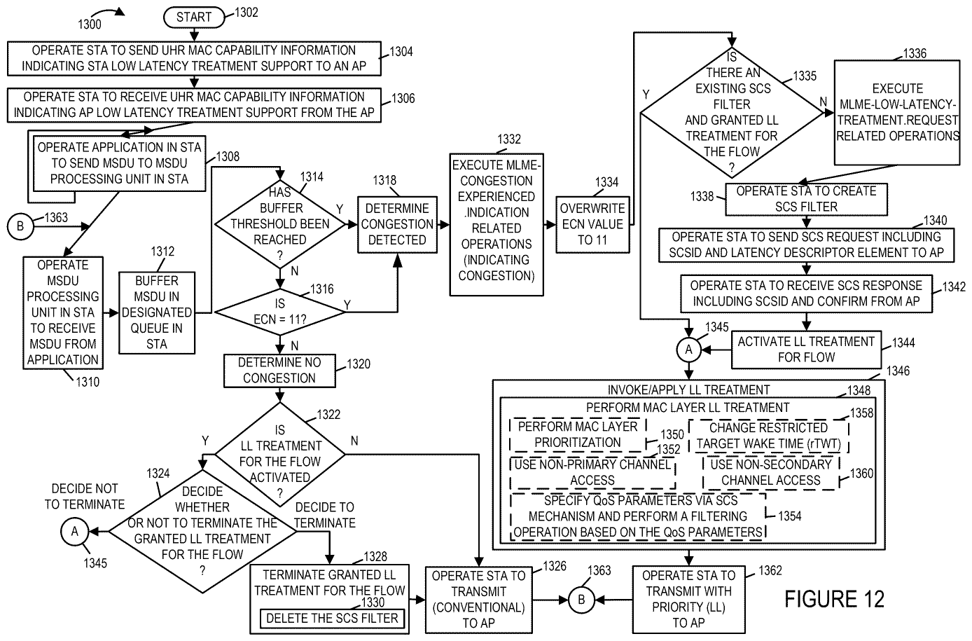

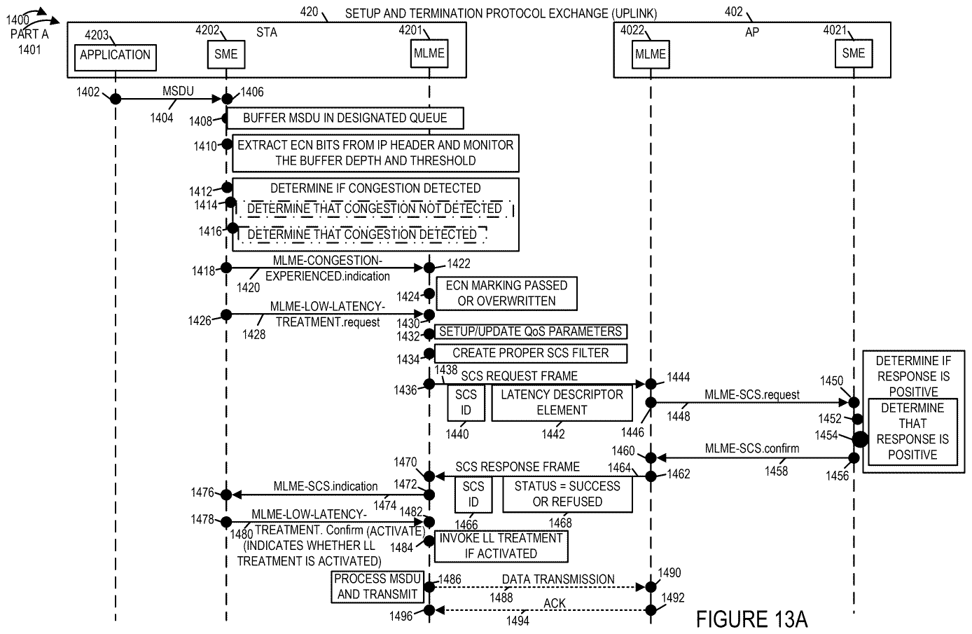

FIG. 12 is a flowchart 1300 of an exemplary method of operating a communications system in accordance with an exemplary embodiment, said method including communication UHR MAC capability information including information indicating support for low latency treatment, receiving MSDUs including ECN bits, monitoring for congestion, creating a SCS filter for a detected congested stream, and applying LL treatment, e.g., at a MAC layer, to facilitate a low latency uplink traffic flow. Operation of the exemplary method starts in step 1302, in which the communications system, e.g., a communications system including an access point AP, a station (STA) and a distribution service (DS), is powered on and initialized. Operation proceeds from start step 1302 to step 1304. In step 1304 the STA is operated to send UHR MAC capability information indicating STA low latency treatment support to an AP. Operation proceeds from step 1304 to step 1306. In step 1306, the STA is operated to receive UHR MAC capability information indicating AP low latency treatment support from the AP. Operation proceeds from step 1306 to step 1308.

In step 1308 an application in the STA is operated to send a MSDU to a MSDU processing unit in the STA. Step 1008 may be, and sometimes is, performed multiple times, e.g., corresponding to different MSDUs which are being sent by the application to the MSDU processing unit in the STA. Operation proceeds from step 1308 to step 1310. In step 1310 the STA is operated to receive the MSDU. Operation proceeds from step 1310 to step 1312. In step 1312 the STA is operated to buffer the received MSDU in a designated queue in the STA. Operation proceeds from step 1312 to step 1314.

In step 1314 the STA determines if a buffer threshold, corresponding to the buffer in which the MSDU was stored, has been reached. If the determination of step 1314 is that the buffer threshold has been reached, then operation proceeds to step 1318, in which the STA determines that congestion has been detected. However, if the determination of step 1314 is that the buffer threshold has not been reached, then operation proceeds from step 1314 to step 1316.

In step 1316, the STA determines if the ECN field in the header of the received MSDU is set to the bit pattern 11. If the STA determines, in step 1316, that the ECN field in the header of the received MSDU is set to 11, then operation proceeds from step 1316 to step 1318, in which the STA determines that congestion has been detected.

Operation proceeds from step 1318 to step 1332, in which the STA executes MLME-congestion experienced.indication related operations, indicating congestion. Operation proceeds from step 1332 to step 1334, in which the AP overwrites the ECN value to bit pattern 11. Operation proceeds from step 1334 to step 1335.

In step 1335 the STA checks to determine if there is an existing stored SCS filter for the flow and granted LL treatment for the flow. If the STA determines, in step 1335, that there is an existing stored SCS filter for the flow and granted LL treatment for the flow, then operation proceeds from step 1335, via connecting node A 1345, to step 1346, in which the STA invokes/applies LL treatment. However, if the STA determines, in step 1335, that there is not an existing stored SCS filter for the flow and granted LL treatment for the flow, then operation proceeds from step 1335 to step 1336, in which the STA executes MLME-low-latency-treatment.request related operations. Operation proceeds from step 1336 to step 1338, in which the STA creates a SCS filter. Operation proceeds from step 1338 to step 1340, in which the STA sends a SCS request including SCSID and a latency descriptor element to the AP. Operation proceeds from step 1340 to step 1342, in which the STA receives an SCS response including the SCSID and confirmation from the AP. Operation proceeds from step 1342 to step 1344, in which the STA activates LL treatment for the flow. Operation proceeds from step 1344, via connecting node A 1345, to step 1346, in which the STA invokes/applies LL treatment for the flow.

Step 1346 includes step 1348, in which the STA performs MAC layer LL treatment. Step 1348 includes one or more of steps 1350, 1352, 1354, 1358 and 1360. In step 1350 the STA performs MAC layer prioritization. In step 1352 the STA uses non-primary access channel. In step 1354, the STA specifies QoS parameters via an SCS mechanism. In step 1358 the STA changes a restricted target wake time (rTWT). In step 1360 the STa uses non-secondary channel access. Operation proceeds from step 1346 to step 1362, in which the STA is operated to transmit the MSDU with priority (LL) to the AP. Operation proceeds from step 1362, via connecting node B 1363 to step 1310, in which the MSDU processing unit in the STA receives another MSDU from the application.

Returning to step 1316, if the STA determines, in step 1316, that the ECN field in the header of the received MSDU is not set to the bit pattern 11, then operation proceeds from step 1316 to step 1320, in which the STA determines that there is no congestion. Operation proceeds from step 1320 to step 1322.

In step 1322, the STA determines if low latency (LL) treatment for the flow is activated. If the determination of step 1322 is that LL treatment for the flow is not activated, then operation proceeds from step 1322 to step 1326, in which the STA is operated to transmit the MSDU (using the conventional approach, e.g., no special LL treatment is applied) to AP. However, if the determination of step 1322 is that LL treatment for the flow is activated, then operation proceeds from step 1322 to step 1324, in which the STA decides whether or not to terminate the granted LL treatment for the flow. If the STA decides, in step 1324, to terminate the granted LL treatment for the flow, then operation proceeds from step 1324 to step 1328, in which the STA terminates the granted LL treatment for the flow. Step 1328 includes step 1330, in which the STA deletes the SCS filter for the flow. Operation proceeds from step 1328 to step 1326, in which the STA is operated to transmit the MSDU (using the conventional approach) to AP. Operation proceeds from step 1326, via connecting node B 1363 to step 1310, in which the MSDU processing unit in the STA receives another MSDU from the application.

Returning to step 1324, if the AP decides, in step 1324, not to terminate the granted LL treatment for the flow, then operation proceeds from step 1324, via connecting node A 1345, to step 1346, in which the STA invokes/applies LL treatment. Step 1346 includes step 1348, in which the STA performs MAC layer LL treatment. Step 1348 includes one or more of: steps 1350, 1352, 1354, 1358 and 1360. In step 1350 the STA performs MAC layer prioritization. In step 1352 the STA uses non-primary access channel. In step 1354, the STA specifies QoS parameters via an SCS mechanism. In step 1358 the STA changes a restricted target wake time (rTWT). In step 1360 the STA uses non-secondary channel access. Operation proceeds from step 1346 to step 1362, in which the STA is operated to transmit the MSDU with priority (LL) to the AP. Operation proceeds from step 1362, via connecting node B 1363 to step 1310, in which the MSDU processing unit in the STA receives another MSDU from the application.

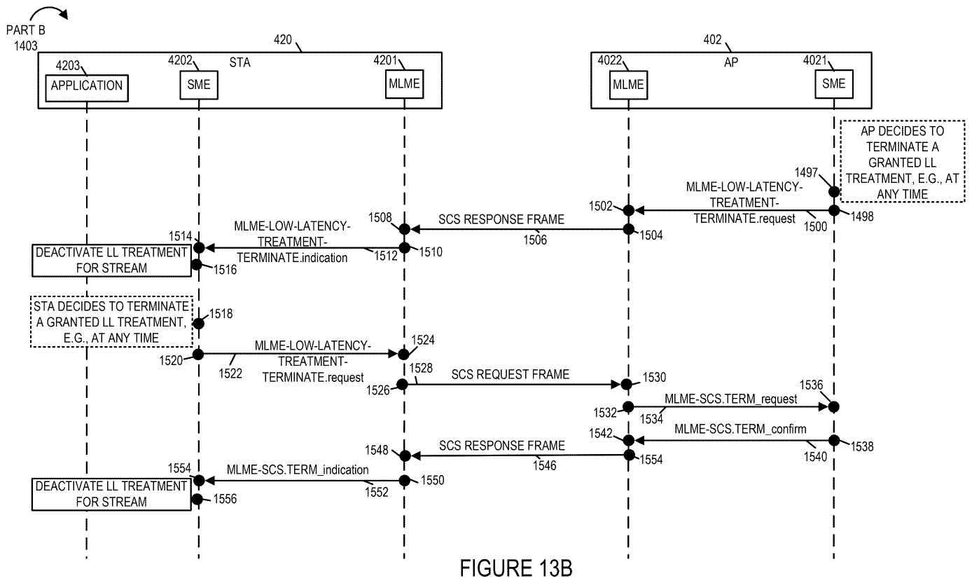

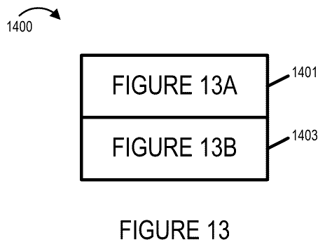

FIG. 13, comprising the combination of FIG. 13A and FIG. 13B is a signaling diagram 1400, comprising Part A 1401 and Part B 1403, illustrating components of an exemplary system and a setup and termination protocol exchange, with regard to uplink, in accordance with an exemplary embodiment. The exemplary system includes distribution service access point (AP) 402 and station (STA) 420. AP 402 includes Station Management Entity (SME) 4021 and MAC Layer Management Entity (MLME) 4022. STA 420 includes MAC Layer Management Entity (MLME) 4201, Station Management Entity (SME) 4202, and application 4203.

In step 1402, application 4203, in STA 420, generates and sends MSDU 1404 to a processing unit in STA 420. In step 1406, the processing unit in STA 420 receives MSDU 1404 and recovers the communicated information including the value of an ECN field. In step 1408 the STA 420 buffers the MSDU in a designated queue. In step 1410 the STA extracts the ECN bits from IP header and monitors the buffer depth and threshold.

In step 1412 the STA 420 determines if congestion has been detected from either the extracted ECN bits indicating congestion, e.g., by a detected bit pattern set to 11, or by the buffer depth in the STA 420 buffer exceeding the threshold, which indicates congestion in the buffer of the STA. An iteration of step 1412 includes one of step 1414 and step 1416. In step 1414, the STA 420 determines that congestion was not detected. In step 1416, the STA 420 determines that congestion was detected.

In response to a determination that congestion was detected, operation proceeds from step 1416 to step 1418. In step 1418, the SME 4202 of STA 420 generates and sends MLME-Congestion-Experienced.indication message 1420 to MLME 4201 of STA 420, which receives message 1420. In response to message 1420, in step 1424 the STA 420 passes or overwrites the ECN marking, e.g., the ECN marking to be communicated to the AP 402 are set to bit pattern 11 to indicate congestion detected.

In step 1426, the SME 4202 of STA 420 generates and sends MLME-LOW-LATENCY-TREATMENT.request message 1428 to MLME 4201 of STA 420, which receives message 1428 in step 1430. In step 1432 the STA 420 sets up/updates QoS parameters. In step 1434 the STA 420 creates a proper SCS filter.

In step 1436 STA 420 generates and sends SCS request frame 1438, which includes SCSID 1440 and latency descriptor element 1442, to AP 402. The SCS request frame 1438 is received by AP 402 in step 1444, and the communicated information is recovered.

In step 1446 MLME 4022 of AP 402 generates and sends MLME-SCS.request message 1448 to SME 4021 of AP 402, which receives message 1448 in step 1450. In step 1452, AP 402 determines if the response to the received request is positive or negative. In step 1454 the AP 402 determines that the response to the request is positive. In response to the positive determination, in step 1456 the SME 4021 of AP 402 generates and sends a MLME-SCS.confirm message 1458 to MLME 4022 of AP 402, which receives message 1458 in step 1460. In step 1462 AP 402 generates and sends a SCS response frame 1464 including a SCSID 1466 and a status field 1468 indicating success or refused. In this example, since the determination of step 1452 is positive, the positive indication is communicated in message 1458, and status field 1468 is set to indicate success. In step 1470 STA 420 receives SCS response frame 1464 and recovers the communicated information.

In step 1472 MLME 4201 of STA 420 generates and sends MLME-SCS.indication message 1474 to SME 4202 of STA 420, which receives message 1474 in step 1476. In step 1478 the SME 4202 of STA 420 generates and sends MLME-LOW-LATENCY-TREATEMENT.Confirm message 1480 to MLME 4201, which indicates whether or not LL treatment is activated. In this example, the MLME-LOW-LATENCY-TREATME.Confirm message 1480 indicates activated. In step 1482, the MLME 4201 of STA 420 receives message 1480 and recovers the communicated information, e.g. indicating the LL treatment is activated. In step 1484 the STA 420 is operated to invokes LL treatment, if activated, for a MSDU to be processed and transmitted. Invoked/applied LL treatments include MAC layer treatments such as, e.g., performing MAC layer prioritization, using non-primary channel access, specifying QoS parameters via SCS mechanisms, changing restricted target wake time (rTWT) and/or using non-secondary channel access.

In step 1486, the STA 420 processes the MSDU and transmits the MSDU, e.g., with LL priority, to AP 402. Data transmission 1488 represents transmission of the processed MSDU from the STA 420 to the AP 402. In step 1490 AP 402 receives the MSDU communicated in data transmission 1488 and recovers the communicated information. In step 1492, the AP 402 generates and sends ACK message 1494 to STA 402, which receives the ACK in step 1496.

At some point in time the AP 402 or STA 420 may, and sometimes does, decide to terminate a granted LL treatment. For example, in step 1497, AP 402 decides to terminate a granted request, and in step 1498, SME 4021 of STA 420 generates and sends MLME-LOW-LATENCY-TREATMENT-TERMINATE.request 1500 to MLME 4022 of AP 402, which receives message 1500 in step 1502. In response to received message 1500, in step 1504, AP 402 generates and sends a SCS response frame 1506 to STA 420, which communicates the low-latency-treatment-terminate request to STA 420. In step 1508, STA 420 receives the SCS response frame 1506, and recovers the communicated information. In response to the received SCS response frame 1506, the MLME 4201 of STA 420 generates and sends, in step 1410, MLME-LOW-LATENCY-TERMINATE.indication message 1512 to SME 4202 of STA 420, which received message 1512 in step 1514. In response to received message 1512, in step 1516, STA 420 deactivates the LL treatment for the stream.

As another example, in step 1518, STA 420 decides to terminate a granted LL treatment, and in step 1520, SME 4202 of STA 420 generates and sends MLME-LOW-LATENCY-TREATMENT-TERMINATE.request 1522 to MLME 4201 of STA 420, which receives message 1522 in step 1524. In response to received message 1522, in step 1526, STA 420 generates and sends a SCS request frame 1528 to AP 02, which communicates the low-latency-treatment-terminate request to AP 402. In step 1530, AP 402 receives the SCS request frame 1528, and recovers the communicated information. In response to the received SCS request frame 1528, the MLME 4022 of AP 402, in step 1532, generates and sends MLME-SCS.TERM_request message 1534 to SME 4021 of AP 402, which receives message 1534 in step 1536. In step 1538, SME 4021 of AP 402, in response to the received MLME-SCS.TERM_request message 1534, generates and sends MLME-SCS.TERM_confirm message 1540 to MLME 4022 of AP 402. In step 1542 MLME 4022 of AP 402 receives MLME-SCS.TERM_confirm message 1540, indicating that the response is positive. In step 1544 AP 402 generates and sends a SCS response frame 1546, indicating that status=success, with regard to the request for LL treatment termination. In step 1548, STA 420 receives the SCS response frame 1546 and recovers the communicated information. In response to the received SCS response frame 1546, the MLME 4201 of STA 420, in step 1550, generates and sends MLME-SCS-TERMINATE.indication message 1552 to SME 4202 of STA 420, which receives message 1552 in step 1554. In response to the received message 1552, in step 1554, STA 420, in step 1556, deactivates the LL treatment for the stream.

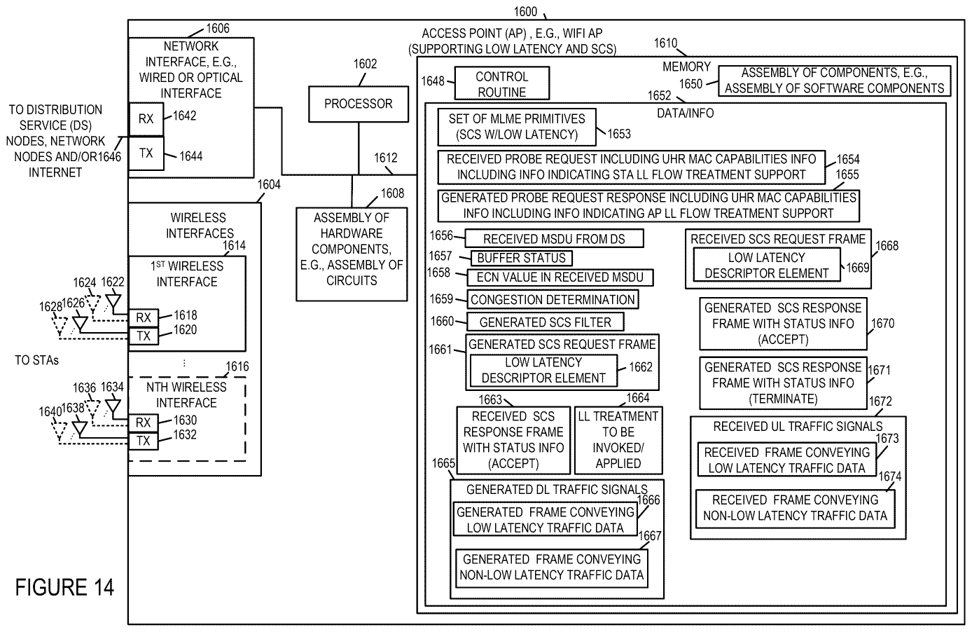

FIG. 14 is a drawing of an exemplary access point (AP) 1600 in accordance with an exemplary embodiment, said exemplary AP, e.g., a WiFi AP, supporting a version of SCS which includes support for low latency treatment. Exemplary access point 1600 is, e.g., AP 1 402 or AP N 404 of system 400 of FIG. 4, AP 904 of FIG. 9, an AP implementing steps of the exemplary method of flowchart 1000 of FIG. 10, AP 402 of signaling diagram 1100 of FIG. 11, an AP implementing steps of the exemplary method of flowchart 1300 of FIG. 12, and/or AP 402 of signaling diagram 1400 of FIG. 13. Exemplary access point (AP) 1600 includes a processor 1602, e.g., a CPU, wireless interfaces 1604, network interface 1606, assembly of hardware components 1608, e.g., an assembly of circuits, and memory 1610 coupled together via a bus 1612 over which the various elements may interchange data and information.

Wireless interfaces 1604 includes one or more wireless interfaces (1st wireless interface 1614, . . . , Nth wireless interface 1616). In some embodiments one or more of the wireless interfaces included in wireless interfaces 1604 are WiFi wireless interfaces. Different wireless interfaces included in wireless interfaces 1604 may correspond to different frequency bands, different communications protocols and/or different communications technologies. 1st wireless interface 1614 includes wireless receiver 1618 and wireless transmitter 1620. Wireless receiver 1618 is coupled to one or more antennas or antennas elements (1622, . . . , 1624) via which the access point 1600 receives wireless signals from stations (STAs). Wireless transmitter 1620 is coupled to one or more antennas or antennas elements (1626, . . . , 1628) via which the access point 1600 transmits wireless signals to STAs. Nth wireless interface 1616 includes wireless receiver 1630 and wireless transmitter 1632. Wireless receiver 1630 is coupled to one or more antennas or antennas elements (1634, . . . , 1636) via which access point 1600 receives wireless signals from STAs. Wireless transmitter 1632 is coupled to one or more antennas or antennas elements (1638, . . . , 1640) via which the access point 1600 transmits wireless signals to STAs. Exemplary wireless signals transmitted by access point 1600 include, e.g., a SCS request frame communicating a request for low latency treatment, e.g., corresponding to a particular downlink stream, or communicating a request for termination of low latency treatment, e.g., corresponding to a particular downlink stream, a SCS response frame, DL traffic signals conveying a low latency data frame, and DL traffic signals conveying a non-low latency data frame. Exemplary wireless signals received by access point 1200 include a SCS request frame communicating a request for low latency treatment, e.g., corresponding to a particular uplink stream, or communicating a request for termination of low latency treatment, e.g., corresponding to a particular uplink stream, a SCS response frame, UL traffic signals conveying a low latency data frame DL traffic signals conveying a low latency data frame, and DL traffic signals conveying a non-low latency data frame.

Network interface 1606, e.g., a wired or optical interface, includes receiver 1642, transmitter 1644 and connector 1646 coupled together. Network interface 1606 couples the access point 1600 to a distribution service, e.g., distribution service 406 of system 400 of FIG. 4, other network nodes and/or the Internet.

Memory 1610 includes control routine 1648, assembly of components 1650, e.g., an assembly of software components, and data/information 1652. Control routine 1648 includes instructions which when executed by processor 1602 control the access point 1600 to implement basic operational functions, e.g., read memory, write to memory, control an interface, load a program, subroutine, or app, etc. Assembly of components 1650, e.g., an assembly of software components, e.g., routines, subroutines, applications, etc., includes, e.g., code, e.g., machine executable instructions, which when executed by processor 1602, controls the AP 1600 to implement steps of a method, e.g., steps of the method of flowchart 1000 of FIG. 10 which are performed by an AP, steps of a method which are performed by AP 402 implementing steps of the method of signaling diagram 1100 of FIG. 11, steps of the method of flowchart 1300 of FIG. 12 which are performed by an AP, steps of a method which are performed by AP 402 implementing steps of the method of signaling diagram 1400 of FIG. 13, and/or steps of the signaling diagram of FIG. 9 which are implemented by AP 902.

Data/information 1652 includes a set of MLME primitives 1653 for supporting SCS w/low latency, a received probe request 1654 from a STA, said received probe request including UHR MAC capabilities information including information indicating STA LL flow treatment support, a generated probe response 1655 to be sent to a STA, said probe response including UHR MAC capabilities information including information indicating AP LL flow treatment support.

Data/information 1652 further includes a received MSDU 1656 from a distribution service (DS), said received MSDU 1656 including an ECN field, buffer status information 1657, an ECN value 1658 extracted from the received MSDU, a congestion determination 1659, a generated SCS filter 1660, a generated SCS request frame 1661 including a low latency descriptor element 1662, a received SCS response frame 1663 with status info, e.g., indicating accept, information 1664 identifying the LL treatment to be invoked/applied, e.g., specific MAC LL treatment to be invoked/applied, and generated DL traffic signals 1665 including a generated frame 1666 conveying low latency traffic data, and a generated frame 1667 conveying non-low latency traffic data.

Data/information 1652 further includes a received SCS request frame 1668 including a low latency descriptor element 1669, a generated SCS response frame 1671 with status information, e.g., indicating accept, a received SCS response frame 1671, e.g., indicating terminate LL treatment, and received UL traffic signals 1672 including a received frame 1673 conveying low latency traffic data and a received frame 1674 conveying non-low latency traffic data.

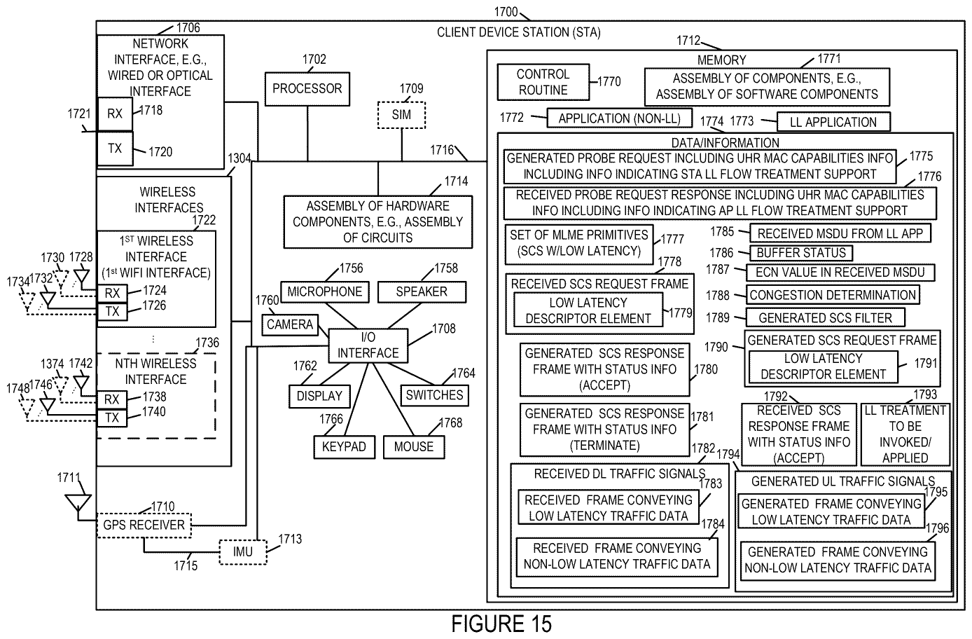

FIG. 15 is a drawing of an exemplary client device station (STA) 1700 in accordance with an exemplary embodiment, said exemplary STA supporting a version of SCS which includes support for low latency treatment. STA 1700 is, e.g., any of the STAs (420, 422, 424, 426, 428, 430) of system 400 of FIG. 4, STA 902 of FIG. 9, a STA implementing operation described with respect to flowchart 1000 of FIG. 10, STA 420 of signaling diagram 11 of FIG. 11, a STA implementing steps of the method of flowchart 1300 of FIG. 12, and/or STA 420 of signaling diagram 1400 of FIG. 13.

Exemplary STA 1700 includes a processor 1702, e.g., a CPU, wireless interfaces 1704, a network interface 1706, an I/O interface 1708, a subscriber identity module (SIM) card 1709, a GPS receiver 1710, an inertial measurement unit (IMU) 1713, which includes gyroscopes and accelerometers, e.g., an IMU on a chip, memory 1712, and an assembly of hardware components 1714, e.g., an assembly of circuits, coupled together via a bus 1716 over which the various elements may interchange data and information.

Wireless interfaces 1704 includes one or more wireless interfaces (1st wireless interface 1722, . . . , Nth wireless interface 1736). In some embodiments wireless interfaces 1704 includes one or more WiFi wireless interfaces. Different wireless interfaces included in wireless interfaces 1704 may correspond to different frequency bands, different communications protocols and/or different communications technologies. 1st wireless interface 1722 includes wireless receiver 1724 and wireless transmitter 1726. Wireless receiver 1724 is coupled to one or more antennas or antennas elements (1728, . . . , 1730) via which the STA 1700 receives wireless signals from access points. Wireless transmitter 1726 is coupled to one or more antennas or antennas elements (1732, . . . , 1734) via which the STA 1700 transmits wireless signals to access points. Nth wireless interface 1736 includes wireless receiver 1738 and wireless transmitter 1740. Wireless receiver 1738 is coupled to one or more antennas or antennas elements (1742, . . . , 1744) via which the STA 1700 receives wireless signals from access points. Wireless transmitter 1740 is coupled to one or more antennas or antennas elements (1746, . . . , 1748) via which the STA 1700 transmits wireless signals to access points. In some embodiments one or more of the same antennas or antenna elements are used by a wireless receiver and a wireless transmitter. Exemplary wireless signals transmitted by STA 1700 include, e.g., a SCS Request frame, a SCS Response frame, and uplink data traffic signals. Exemplary wireless signals received by STA 1700 include e.g., a SCS request frame, a SCS response frame, and DL traffic signals conveying a low latency data frame, and DL traffic signals conveying a non-low latency data frame.

Network interface 1706, e.g., a wired or optical interface, includes receiver 1718, transmitter 1722 and connector 1721 coupled together. Network interface 1706 allows the STA 1700 to be coupled to network nodes and/or the Internet, via a wireline interface connection, when available.

GPS receiver 1710 is coupled to GPS antenna 1710 via which the STA 1700 receives GPS signals from satellites. IMU 1713 is coupled to GPS receiver 1710 via connection 1715. The GPS receiver 1710 determines time, position, and velocity information based on the received GPS signals. In some embodiments, the GPS receiver 1710 and/or the processor 1702 uses IMU 1713 measurement information in addition to the received GPS signals to determine time, position, velocity information, and/or other navigation information. For example, the GPS receiver 1713 and/or processor 1702 uses the IMU information to aid determination of STA location, when GPS reception is unavailable or of low quality. The SIM card 1709, GPS receiver 1710 and IMU 1713 are optional elements which may or may not be included in STA 1700.

STA 1700 further includes a plurality of I/O devices (microphone 1756, speaker 1758, camera 1760, display 1762, e.g. a touch screen display, switches 1764, keypad 1766 and mouse 1768) coupled to I/O interface 1708, via which the various I/O devices may interface with other elements within STA 1700.

Memory 1712 includes control routine 1770, assembly of components 1772, e.g., an assembly of software components, and data/information 1744. Control routine 1770 includes instructions which when executed by processor 1702 control the STA 1700 to implement basic operational functions, e.g., read memory, write to memory, control an interface, load a program, subroutine, or app, etc. Assembly of components 1772, e.g., an assembly of software components, e.g., routines, subroutines, applications, etc., includes, e.g., code, e.g., machine executable instructions, which when executed by processor 1702, controls the STA 1700 to implement steps of a method, e.g., steps of a method which are performed by STA 420 implementing steps of the method of signaling diagram 1100 of FIG. 11, steps of a method which are performed by STA 420 implementing steps of the method of signaling diagram 1400 of FIG. 34, steps of a method of signaling diagram 900 of FIG. 9 which are performed by STA 902, operations described with respect to flowchart 1000 of FIG. 10 which are implemented by a STA, and/or steps of the flowchart 1300 of FIG. 12, which are performed by a STA.

Data/information 1774 includes a set of MLME primitives 1777 which support SCS w/Low Latency, a generated probe request 1775 to be sent to an AP, said generated probe request including UHR MAC capabilities information including information indicating STA low latency (LL) flow treatment support, a received probe response 1776 from an AP, said received probe response including UHR MAC capabilities information including information indicating AP low latency (LL) flow treatment support.

Data/information 1774 further includes a received SCS request frame 1778 including a low latency descriptor element 1779, a generated SCS response frame 1780 with status information, e.g., indicating accept, a received SCS response frame 1781, e.g., indicating terminate LL treatment, and received DL traffic signals 1782 including a received frame 1783 conveying low latency traffic data and a received frame 1784 conveying non-low latency traffic data.

Data/information 1774 further includes a received MSDU 1785 from a LL application resident on STA 1700, said received MSDU 1785 including an ECN field, buffer status information 1786, an ECN value 1787 extracted from the received MSDU, a congestion determination 1788, a generated SCS filter 1789, a generated SCS request frame 1790 including a low latency descriptor element 1791, a received SCS response frame 1792 with status info, e.g., indicating accept, information 1793 identifying the LL treatment to be invoked/applied, e.g., specific MAC LL treatment to be invoked/applied, and generated UL traffic signals 1794 including a generated frame 1795 conveying low latency traffic data, and a generated frame 1796 conveying non-low latency traffic data.

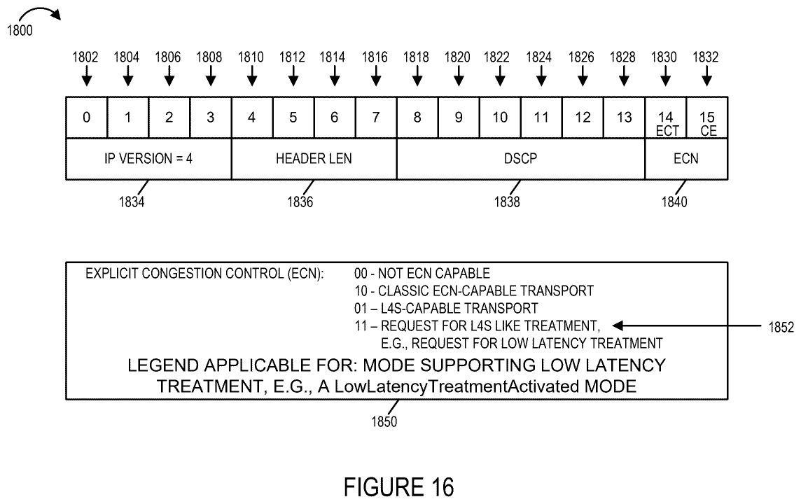

FIG. 16 is a drawing of an exemplary IP header 1800 including an ECN portion 1840 and a legend 1850 illustrating the mapping of ECN bit values for a mode supporting low latency treatment, e.g., a LowLatencyTreatmentActivated mode. IP header 1800 includes 16 bits (Bit 0 1802, Bit 1 1804, Bit 2 1806, Bit 3, 1808, Bit 4 1810, Bit 5 1812, Bit 6 1814, Bit 7 1816, Bit 8 1818, Bit 9 1820 Bit 10 1822, Bit 11 1824, Bit 12 1826, Bit 13 1828, Bit 14 1830, Bit 15 1832). First IP header portion 1834, which includes Bit 0 1802, Bit 1 1804, Bit 2 1806 and Bit 3 1808, is used to convey the IP version, e.g. IP version=4. Second IP header portion 1836, which includes Bit 4 1810, Bit 5 1812, Bit 6 1814 and Bit 7 1816, is used to convey the Header Length (Len). Third IP header portion 1838, which includes Bit 8 1818, Bit 9 1820, Bit 10 1822, Bit 11 1824, Bit 12 1826, and Bit 13 1828, is used to convey Differential Service Code Point (DSCP). Fourth IP header portion 1840 which includes Bit 14 1830, which is the ECT bit, and Bit 15 1832, which is the CE bit, is used to convey the Explicit Congestion control Notification (ECN) bits.

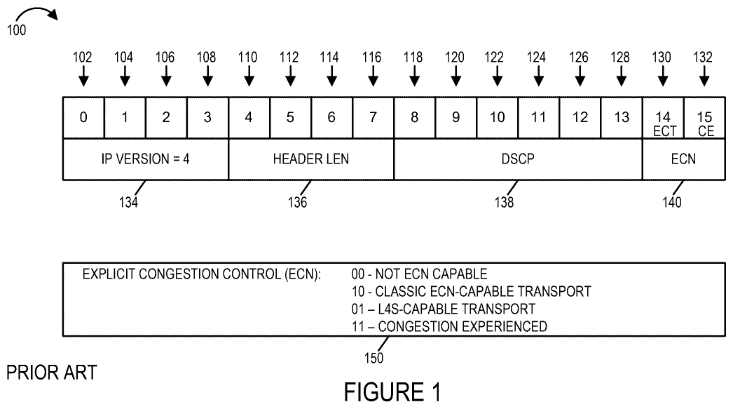

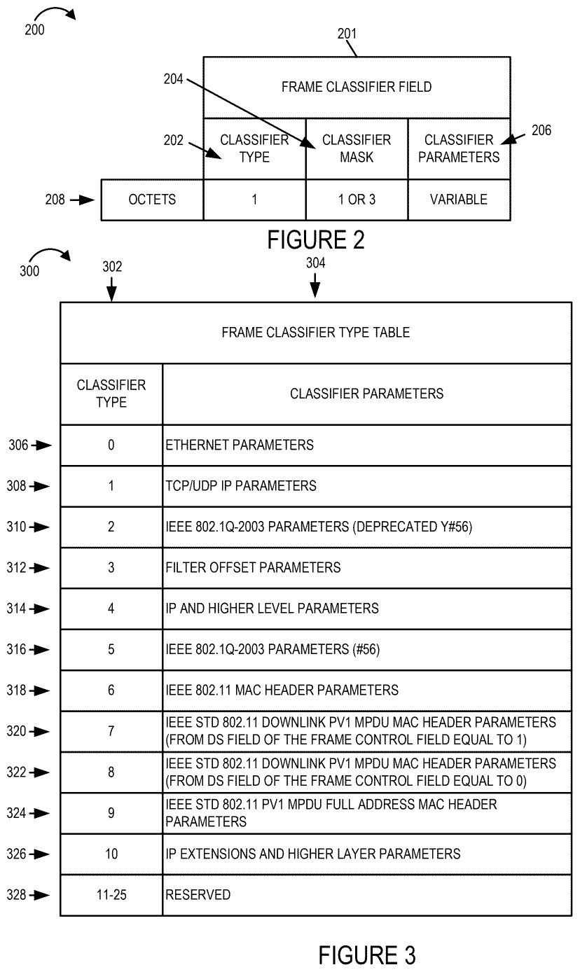

Legend 1850, which is applicable for: a mode supporting low latency treatment, e.g., a LowLatencyTreatmentActivatedMode, indicates: ECN bit pattern=00 means not ECN capable; ECN bit pattern=10 means classic ECN-capable transport; ECN bit pattern=01 means L4S-capable transport; and ECN bit pattern=11 means request for L4S like treatment, e.g., a request for low latency treatment (1852). The mapping of the ECN bits for pattern=11 (used for the mode supporting low latency treatment, e.g., Low Latency Treatment Activated mode), as shown in FIG. 16, is a different meaning than the convention mapping for ECN bit pattern=11 shown in legend 150 of FIG. 1.

### 1st List of Numbered Exemplary Method Embodiments

Method Embodiment 1. A method of operating a first communications device (AP 402 or STA 420), the method comprising: transmitting (1040 or 1340) from the first communications device (AP 402 or STA 420) to a second communications device (STA 420 or AP 402) a Stream Classification Service (SCS) request frame (701) including a latency descriptor element (746) including information relating to treatment of a first data flow; applying, at the first device (AP 402 or STA 420), a low latency treatment (1046 or 1346) to a first medium access control (MAC) service data unit (MSDU) corresponding to said first data flow; and transmitting (1062 or 1362) the first MSDU from the first communications device (AP 402 or STA 420) to the second communications device (STA 420 or AP 402).

Method Embodiment 1A. The method of Method Embodiment 1, wherein the SCS request frame (701) includes a first SCS Identifier (SCSID) (716) identifying the first data flow; and wherein said data flow is SCS data flow corresponding to said first SCSID (716).

Method Embodiment 1A1. The method of Method Embodiment 1A, wherein the SCSID identifies the SCS stream (the congestion experienced stream) to which the first MSDU belongs.

Method Embodiment 1B. The method of Method Embodiment 1A, further comprising: operating the first communications device (AP 402 or STA 420) to receive (1042 or 1342) an SCS response frame (801) from the second communications device (STA 420 or AP 402), said SCS response frame (801) including the first SCSID (810) and confirming that the second communications device (STA 420 or AP 402) has agreed to the SCS request (e.g., via a status field (812), included in the SCS response frame (801) and corresponding to the first SCSID, conveying information indicating success).

Method Embodiment 2. The method of Method Embodiment 1, further comprising: determining (1018 or 1318), at the first communications device, that congestion was detected with regard to the first data flow; and activating (1044 or 1344), at the first communications device, the low latency treatment for the first data flow.

Method Embodiment 2A. The method of Method Embodiment 2, further comprising: operating the first communications device to create (1038 or 1338) an SCS filter corresponding to the first data flow.

Method Embodiment 2A1. The method of Method Embodiment 2, wherein applying (1046 or 1346) a low latency treatment to a first medium access control (MAC) service data unit (MSDU) corresponding to said first data flow includes performing (1048 or 1348) a MAC layer low latency (LL) treatment to the first MSDU corresponding to the first data flow.

Method Embodiment 2AA. The method of Method Embodiment 2, wherein applying (1046 or 1346) the low latency treatment to the first MSDU includes performing mac layer prioritization (1050 or 1350) by providing the first MSDU a higher transmission priority than an MSDU not subject to the low latency treatment.

Method Embodiment 2AB. The method of Method Embodiment 2, wherein applying (1046 or 1346) the low latency treatment to the first MSDU includes providing (1052 or 1352) the first MSDU non-primary channel access thereby allowing the first MSDU to be transmitted over a secondary channel.

Method Embodiment 2AC. The method of Method Embodiment 2, wherein applying (1046 or 1346) the low latency treatment to the first MSDU includes specifying (1054 or 1354) QoS parameters to be applied during communication of the first MSDU via an SCS mechanism.

Method Embodiment 2D. The method of Method Embodiment 2, wherein applying (1046 or 1346) the low latency treatment to the first MSDU includes changing (1058 or 1358) a restricted target wake time (rTWT) to decrease a target wake time, as compared to a target wake time used for data traffic not provided a low latency treatment.

Method Embodiment 2E. The method of Method Embodiment 2, wherein applying (1046 or 1346) the low latency treatment to the first MSDU includes using (1060 or 1360) non-secondary channel access when communicating the first MSDU to the second communications device.

Method Embodiment 3. The method of Method Embodiment 2, further comprising: receiving (1004 or 1306), at the first communications device (AP 402 or STA 420) from the second communications device (STA 420 or AP 402), UHR MAC capability information indicating second communication device support for low latency treatment for data flows.

Method Embodiment 4. The method of Method Embodiment 3, further comprising: sending (1006 or 1304), from the first communications device (AP 402 or STA 420) to the second communications device (STA 420 or AP 402), UHR MAC capability information indicating first communications device low latency treatment support for data flows.

Method Embodiment 5. The method of Method Embodiment 1, wherein the first communications device (402) is an access point (AP) and wherein the second communications device (420) is a station (STA) (e.g., a non-AP STA).

Method Embodiment 5A. The method of Method Embodiment 5, wherein said first MSDU is an MSDU received by the AP (402) from a distribution system (406) which distributes data to APs (402, 404).

Method Embodiment 6. The method of Method Embodiment 5, wherein said data flow is a downlink data flow; and wherein applying (1046), at the first communications device, a low latency treatment to the first MSDU corresponding to said data flow includes: performing (1054) a filtering operation at said first device (402) on the first MSDU.

Method Embodiment 7. The method of Method Embodiment 1, wherein the first communications device (420) is a station (STA) (e.g., a non-AP STA) and wherein the second communications device (402) is an access point (AP).

Method Embodiment 7A. The method of Method Embodiment 7, wherein said first MSDU is an MSDU from an application (4203 or 1773) located on the STA (420).

Method Embodiment 8. The method of Method Embodiment 7, wherein applying (1346), at the first device (420), a low latency treatment to the first MSDU corresponding to said data flow includes: performing (1354) a filtering operation at said first communications device (420) on the first MSDU.

Method Embodiment 9. The method of Method Embodiment 1, wherein said latency descriptor element (746) includes at least two of: i) an ECN field (750), ii) a ECN threshold field (752), iii) a latency target field (754), iv) a desired bandwidth field (756) or v) a loss tolerance field (758) (or any possible combination of one, more than one, or all of these fields (i, ii, iii, iv and/or v)).

Method Embodiment 9A. The method of Method Embodiment 9, wherein the latency descriptor element (746) does not include a L4S classifier mask field or queue designation field.

Method Embodiment 10. The method of Method Embodiment 1, wherein said latency descriptor element (746) is included as part of a QoS characteristics element (726), which is included as part of a SCS descriptor element (710).

### 1st List of Numbered Exemplary Apparatus Embodiments

Apparatus Embodiment 1. An access point (AP) (402 or 1600), the AP comprising: a wireless transmitter (1620); and a processor (1602) configured to operate the AP to: transmit (1040) (via wireless transmitter 1620) from the AP to a station (STA) (420) a Stream Classification Service (SCS) request frame (701) including a latency descriptor element (746) including information relating to treatment of a first data flow; apply, at the AP, a low latency treatment (1046) to a first medium access control (MAC) service data unit (MSDU) corresponding to said first data flow; and transmit (1062) (via wireless transmitter 1620) the first MSDU from the AP to the STA 420.

Apparatus Embodiment 1A. The AP of Apparatus Embodiment 1, wherein the SCS request frame (701) includes a first SCS Identifier (SCSID) (716) identifying the first data flow; and wherein said data flow is SCS data flow corresponding to said first SCSID (716).

Apparatus Embodiment 1A1. The AP of Apparatus Embodiment 1A, wherein the SCSID identifies the SCS stream (the congestion experienced stream) to which the first MSDU belongs.

Apparatus Embodiment 1B. The AP of Apparatus Embodiment 1A, further comprising: a wireless receiver (1618); and wherein said processor (1602) is further configured to: operate the AP to receive (1042) (via wireless receiver 1618) an SCS response frame (801) from the STA, said SCS response frame (801) including the first SCSID (810) and confirming that the STA has agreed to the SCS request (e.g., via a status field (812), included in the SCS response frame (801) and corresponding to the first SCSID, conveying information indicating success).

Apparatus Embodiment 2. The AP of Apparatus Embodiment 1, wherein said processor (1602) is further configured to: determine (1018), at the AP, that congestion was detected with regard to the first data flow; and operate the AP to activate (1044), at the AP, the low latency treatment for the first data flow.

Apparatus Embodiment 2A. The AP of Apparatus Embodiment 2, wherein said processor (1602) is further configured to: operate the AP to create (1038 or 1338) an SCS filter corresponding to the first data flow.

Apparatus Embodiment 2A1. The AP of Apparatus Embodiment 2, wherein said processor (1602) is configured to operate the AP to: perform (1048) a MAC layer low latency (LL) treatment to the first MSDU corresponding to the first data flow, as part of being configured to apply (1046) a low latency treatment to a first medium access control (MAC) service data unit (MSDU) corresponding to said first data flow.

Apparatus Embodiment 2AA. The AP of Apparatus Embodiment 2, wherein said processor (1602) is configured to operate the AP to: perform mac layer prioritization (1050 or 1350) by providing the first MSDU a higher transmission priority than an MSDU not subject to the low latency treatment, as part of being configured to apply (1046) the low latency treatment to the first MSDU.

Apparatus Embodiment 2AB. The AP of Apparatus Embodiment 2, wherein said processor (1602) is configured to operate the AP to: provide (1052) the first MSDU non-primary channel access thereby allowing the first MSDU to be transmitted over a secondary channel, as part of being configured to apply (1046) the low latency treatment to the first MSDU.

Apparatus Embodiment 2AC. The AP of Apparatus Embodiment 2, wherein said processor (1602) is configured to operate the AP to: specify (1054) QoS parameters to be applied during communication of the first MSDU via an SCS mechanism, as part of being configured to apply (1046) the low latency treatment to the first MSDU.

Apparatus Embodiment 2D. The AP of Apparatus Embodiment 2, wherein said processor (1602) is configured to operate the AP to: change (1058) a restricted target wake time (rTWT) to decrease a target wake time, as compared to a target wake time used for data traffic not provided a low latency treatment, as part of being configured to applying (1046) the low latency treatment to the first MSDU.

Apparatus Embodiment 2E. The AP of Apparatus Embodiment 2, wherein said processor (1602) is configured to operate the AP to: use (1060) non-secondary channel access when communicating the first MSDU to the second communications device, as part of being configured to apply (1046) the low latency treatment to the first MSDU.

Apparatus Embodiment 3. The AP of Apparatus Embodiment 2, further comprising: a wireless receiver (1618); and wherein said processor (1602) is further configured to operate the AP to: receive (1004), (via the wireless receiver 1618) at the AP from the STA, UHR MAC capability information indicating STA support for low latency treatment for data flows.

Apparatus Embodiment 4. The AP of Apparatus Embodiment 3, wherein said processor (1602) is further configured to operate the AP to: send (1006), (via the wireless transmitter 1620) from the AP to the STA, UHR MAC capability information indicating AP low latency treatment support for data flows.

Apparatus Embodiment 5. The AP of Apparatus Embodiment 1, wherein the AP (402) is an access point (AP) which supports low latency treatment and wherein the STA (420) is a STA (e.g., a non-AP STA) which supports low latency treatment.

Apparatus Embodiment 5A. The AP of Apparatus Embodiment 5, wherein said first MSDU is an MSDU received by the AP (402) from a distribution system (406) which distributes data to APs (402, 404).

Apparatus Embodiment 6. The AP of Apparatus Embodiment 5, wherein said data flow is a downlink data flow; and wherein said processor (1602) is configured to operate the AP to perform (1054) a filtering operation at said AP on the first MSDU, as part of being configured to operate the AP to apply (1046), at the AP, a low latency treatment to the first MSDU corresponding to said data flow.

Apparatus Embodiment 9. The AP of Apparatus Embodiment 1, wherein said latency descriptor element (746) includes at least two of: i) an ECN field (750), ii) a ECN threshold field (752), iii) a latency target field (754), iv) a desired bandwidth field (756) or v) a loss tolerance field (758) (or any possible combination of one, more than one, or all of these fields (i, ii, iii, iv and/or v)).

Apparatus Embodiment 9A. The AP of Apparatus Embodiment 9, wherein the latency descriptor element (746) does not include a L4S classifier mask field or queue designation field.

Apparatus Embodiment 10. The AP of Apparatus Embodiment 1, wherein said latency descriptor element (746) is included as part of a QoS characteristics element (726), which is included as part of a SCS descriptor element (710).

### 2nd List of Numbered Exemplary Apparatus Embodiments

Apparatus Embodiment 1. A station (STA) (420 or 1700), the STA comprising: a wireless transmitter (1726); and a processor (1702) configured to operate the STA to: transmit (1340) (via the wireless transmitter 1726) from the STA to an access point (AP) (402) a Stream Classification Service (SCS) request frame (701) including a latency descriptor element (746) including information relating to treatment of a first data flow; apply, at the STA, a low latency treatment (1046 or 1346) to a first medium access control (MAC) service data unit (MSDU) corresponding to said first data flow; and transmit (1362) (via the wireless transmitter 1726) the first MSDU from the STA to the AP.

Apparatus Embodiment 1A. The STA of Apparatus Embodiment 1, wherein the SCS request frame (701) includes a first SCS Identifier (SCSID) (716) identifying the first data flow; and wherein said data flow is SCS data flow corresponding to said first SCSID (716).

Apparatus Embodiment 1A1. The STA of Apparatus Embodiment 1A, wherein the SCSID identifies the SCS stream (the congestion experienced stream) to which the first MSDU belongs.

Apparatus Embodiment 1B. The STA of Apparatus Embodiment 1A, further comprising: a wireless receiver (1724); and wherein said processor (1702) is further configured to operate the STA to: receive (1342) (via wireless receiver 1724) an SCS response frame (801) from the AP, said SCS response frame (801) including the first SCSID (810) and confirming that the AP has agreed to the SCS request (e.g., via a status field (812), included in the SCS response frame (801) and corresponding to the first SCSID, conveying information indicating success).

Apparatus Embodiment 2. The STA of Apparatus Embodiment 1, wherein said processor (1702) is further configured to operate the STA to: determine (1318), at the STA, that congestion was detected with regard to the first data flow; and activate (1044 or 1344), at the STA, the low latency treatment for the first data flow.

Apparatus Embodiment 2A. The STA of Apparatus Embodiment 2, wherein said processor (1702) is further configured to: operate the STA to create (1338) an SCS filter corresponding to the first data flow.

Apparatus Embodiment 2A1. The STA of Apparatus Embodiment 2, wherein said processor (1702) is further configured to operate the STA to: perform (1348) a MAC layer low latency (LL) treatment to the first MSDU corresponding to the first data flow, as part of being configured to apply (1346) a low latency treatment to a first medium access control (MAC) service data unit (MSDU) corresponding to said first data flow.

Apparatus Embodiment 2AA. The STA of Apparatus Embodiment 2, wherein said processor (1702) is further configured to operate the STA to: perform mac layer prioritization (1050 or 1350) by providing the first MSDU a higher transmission priority than an MSDU not subject to the low latency treatment.

Apparatus Embodiment 2AB. The STA of Apparatus Embodiment 2, wherein said processor (1702) is configured to operate the STA to: provide (1352) the first MSDU non-primary channel access thereby allowing the first MSDU to be transmitted over a secondary channel, as part of being configured to apply (1346) the low latency treatment to the first MSDU,

Apparatus Embodiment 2AC. The STA of Apparatus Embodiment 2, wherein said processor (1702) is configured to operate the STA to: specify (1354) QoS parameters to be applied during communication of the first MSDU via an SCS mechanism, as part of being configured to applying (1346) the low latency treatment to the first MSDU.

Apparatus Embodiment 2D. The STA of Apparatus Embodiment 2, wherein said processor (1702) is configured to operate the STA to: change (1358) a restricted target wake time (rTWT) to decrease a target wake time, as compared to a target wake time used for data traffic not provided a low latency treatment, as part of being configured to apply (1346) the low latency treatment to the first MSDU.

Apparatus Embodiment 2E. The STA of Apparatus Embodiment 2, wherein said processor (1702) is configured to operate the STA to: use (1360) non-secondary channel access when communicating the first MSDU to the second communications device, as part of being configured to apply (1346) the low latency treatment to the first MSDU.

Apparatus Embodiment 3. The STA of Apparatus Embodiment 2, further comprising: a wireless receiver (1724); and wherein said processor (1702) is further configured to operate the STA to: receive (1306) (via the wireless receiver 1724), at the first communications STA from the AP 402, UHR MAC capability information indicating AP support for low latency treatment for data flows.

Apparatus Embodiment 4. The STA of Apparatus Embodiment 3, wherein said processor (1702) is further configured to operate the STA to: send (1304), (via the wireless transmitter 1726) from the STA to the AP, UHR MAC capability information indicating STA low latency treatment support for data flows.

Apparatus Embodiment 7. The STA of Apparatus Embodiment 1, wherein the STA is a station (STA) (e.g., a non-AP STA), which supports low latency treatment and wherein the AP is an AP, which supports low latency treatment.

Apparatus Embodiment 7A. The STA of Apparatus Embodiment 7, wherein said first MSDU is an MSDU from an application (4203 or 1773) located on the STA.

Apparatus Embodiment 8. The STA of Apparatus Embodiment 7, wherein said processor (1702) is configured to operate the STA to: perform (1354) a filtering operation at said STA on the first MSDU, as part of being configured to apply (1346), at the STA, a low latency treatment to the first MSDU corresponding to said data flow.

Apparatus Embodiment 9. The STA of Apparatus Embodiment 1, wherein said latency descriptor element (746) includes at least two of: i) an ECN field (750), ii) a ECN threshold field (752), iii) a latency target field (754), iv) a desired bandwidth field (756) or v) a loss tolerance field (758) (or any possible combination of one, more than one, or all of these fields (i, ii, iii, iv and/or v)).

Apparatus Embodiment 9A. The STA of Apparatus Embodiment 9, wherein the latency descriptor element (746) does not include a L4S classifier mask field or queue designation field.

Apparatus Embodiment 10. The STA of Apparatus Embodiment 1, wherein said latency descriptor element (746) is included as part of a QoS characteristics element (726), which is included as part of a SCS descriptor element (710).

Various embodiments are directed to a non-transitory machine readable storage device, e.g., memory, with processor executable instructions stored thereon, which when executed by a processor of an apparatus, e.g., access point or station, control the apparatus to implement any one or more of the above described methods or numbered method embodiments.

The techniques of various embodiments may be implemented using software, hardware and/or a combination of software and hardware. Various embodiments are directed to apparatus, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., access point (AP), e.g., WiFi AP, supporting SCS and/or MSCS, station (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., access points (AP), e.g., WiFi AP, supporting SCS and/or MSCS, stations (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an access point (AP), e.g., WiFi AP, supporting SCS and/or MSCS, a stations (STA), e.g., a WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such an access points (AP), e.g., a WiFi AP, supporting SCS and/or MSCS, a station (STA), e.g., WiFi STA, supporting SCS and/or MSCS, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating a first communications device, the method comprising:
transmitting from the first communications device to a second communications device a Stream Classification Service (SCS) request frame including a latency descriptor element including information relating to treatment of a first data flow;
applying, at the first communications device, a low latency treatment to a first medium access control (MAC) service data unit (MSDU) corresponding to said first data flow; and
transmitting the first MSDU from the first communications device to the second communications device.

2. The method of claim 1, further comprising:
determining, at the first communications device, that congestion was detected with regard to the first data flow; and
activating, at the first communications device, the low latency treatment for the first data flow.

3. The method of claim 2, further comprising:
receiving, at the first communications device from the second communications device, UHR MAC capability information indicating second communication device support for low latency treatment for data flows.

4. The method of claim 3, further comprising:
sending, from the first communications device to the second communications device, UHR MAC capability information indicating first communications device low latency treatment support for data flows.

5. The method of claim 1, wherein the first communications device is an access point (AP) and wherein the second communications device is a station (STA).

6. The method of claim 5,
wherein said data flow is a downlink data flow; and
wherein applying, at the first communications device, a low latency treatment to the first MSDU corresponding to said data flow includes:
performing a filtering operation at said first device on the first MSDU.

7. The method of claim 1, wherein the first communications device is a station (STA) and wherein the second communications device is an access point (AP).

8. The method of claim 7, wherein applying, at the first device, a low latency treatment to the first MSDU corresponding to said data flow includes:
performing a filtering operation at said first communications device on the first MSDU.

9. The method of claim 1, wherein said latency descriptor element includes at least two of: i) an ECN field, ii) a ECN threshold field, iii) a latency target field, iv) a desired bandwidth field or v) a loss tolerance field.

10. The method of claim 1, wherein said latency descriptor element is included as part of a QoS characteristics element, which is included as part of a SCS descriptor element.

11. An access point (AP), the AP comprising:
a wireless transmitter; and
a processor configured to operate the AP to:
transmit from the AP to a station (STA) a Stream Classification Service (SCS) request frame including a latency descriptor element including information relating to treatment of a first data flow;
apply, at the AP, a low latency treatment to a first medium access control (MAC) service data unit (MSDU) corresponding to said first data flow; and
transmit the first MSDU from the AP to the STA.

12. The AP of claim 11, wherein said processor is further configured to:
determine, at the AP, that congestion was detected with regard to the first data flow; and
operate the AP to activate, at the AP, the low latency treatment for the first data flow.

13. The AP of claim 12, further comprising:
a wireless receiver; and
wherein said processor is further configured to operate the AP to:
receive, at the AP from the STA, UHR MAC capability information indicating STA support for low latency treatment for data flows.

14. The AP of claim 13, wherein said processor is further configured to operate the AP to:
send, from the AP to the STA, UHR MAC capability information indicating AP low latency treatment support for data flows.

15. The AP of claim 11, wherein the AP is an AP which supports low latency treatment and wherein the STA is a STA which supports low latency treatment.

16. A station (STA), the STA comprising:
a wireless transmitter; and
a processor configured to operate the STA to:
transmit from the STA to an access point (AP) a Stream Classification Service (SCS) request frame including a latency descriptor element including information relating to treatment of a first data flow;
apply, at the STA, a low latency treatment to a first medium access control (MAC) service data unit (MSDU) corresponding to said first data flow; and
transmit the first MSDU from the STA to the AP.

17. The STA of claim 16, wherein said processor is further configured to operate the STA to:
determine, at the STA, that congestion was detected with regard to the first data flow; and
activate, at the STA, the low latency treatment for the first data flow.

18. The STA of claim 17, further comprising:
a wireless receiver; and
wherein said processor is further configured to operate the STA to:
receive, at the first communications STA from the AP, UHR MAC capability information indicating AP support for low latency treatment for data flows.

19. The STA of claim 18, wherein said processor is further configured to operate the STA to:
send, from the STA to the AP, UHR MAC capability information indicating STA low latency treatment support for data flows.

20. The STA of claim 16, wherein the STA is a STA, which supports low latency treatment and wherein the AP is an AP, which supports low latency treatment.
